(19) United States
(12) Patent Application Publication
(10) Pub. No.: US 2026/0231985 A1
(43) Pub. Date: Aug. 13, 2026

(54) FOAMING BEVERAGE WITH COLLAGEN PEPTIDES

(71) Applicant: PepsiCo, Inc., Purchase, NY (US)

(72) Inventors: Seyhun GEMILI, Montville, NJ (US); Joseph GLEASON, Suffield, CT (US)

(21) Appl. No.: 19/463,689

(22) Filed: Jan. 29, 2026

Related U.S. Application Data
(60) Provisional application No. 63/750,872, filed on Jan. 29, 2025.

(51) Int. Cl. A23L 2/39; A23L 2/38; A23L 2/54; A23L 2/60; A23L 2/66; A23L 2/68

(52) U.S. Cl. CPC A23L 2/39; A23L 2/38; A23L 2/54; A23L 2/60; A23L 2/66; A23L 2/68

(57) ABSTRACT

The present disclosure provides methods of generating and stabilizing foam in beverages made from ready-to-mix powder bases that contain collagen.

### BACKGROUND

In recent years, consumers have been looking for more from their beverages of choice than a good flavor. As a result, beverages are now being formulated with ingredients such as collagen, which is known to improve skin health. However, the ingredients used to deliver these benefits often alter the taste of the beverage, forcing consumers to trade taste for these beneficial properties.

Foaming beverages enhance flavor and refreshment. However, collagen peptides, while capable of capturing gas to generate a foam, generally produce foams that collapse quickly. While sugars have been used to generate and stabilize foam beverages, there is a continuing need to find ways to stabilize the bubbles in healthy beverages that do not require the use of high amounts of sugar.

### BRIEF SUMMARY

In a first aspect, the present disclosure provides a powder base for preparing a beverage comprising:
a) collagen;
b) one or more acids;
c) one or more bases; and
d) one or both of:
   i) a polyphenol-containing substance, and
   ii) a glycolipid.

In some aspects, the glycolipid is selected from the group consisting of glycoglycerolipids, glycosphingolipids, sugar-linked sugar alcohol lipids. phosphoglycolipds, trehalose glycolipids, sophorose glycolipids, rhamnose glycolipids, phenolic glycoloipds, steryl glycolipids, and combinations thereof.

In some aspects, the glycoglycerolipids are selected from the group consisting of monoglycosyl diacylglycerol, diglycosyl diacylglycerol, triglycosyl diacylglycerol, aminoglycoglycerolipids, glucuronosylglycerolipids, sulfoglycoglycerolipds, and combinations thereof.

In some aspects, the glycosphingolipids are selected from the group consisting of cerebrosides, oligoglycosylceramides, sulfatides, gangliosides, and combinations thereof.

In some aspects, the sugar-linked sugar alcohol lipids are selected from the group consisting of mannosylerythritol lipids, acremomannolipin A, and a combination thereof.

In some aspects, the glycolipid is a compound of Formula I, Formula II, or a combination thereof:

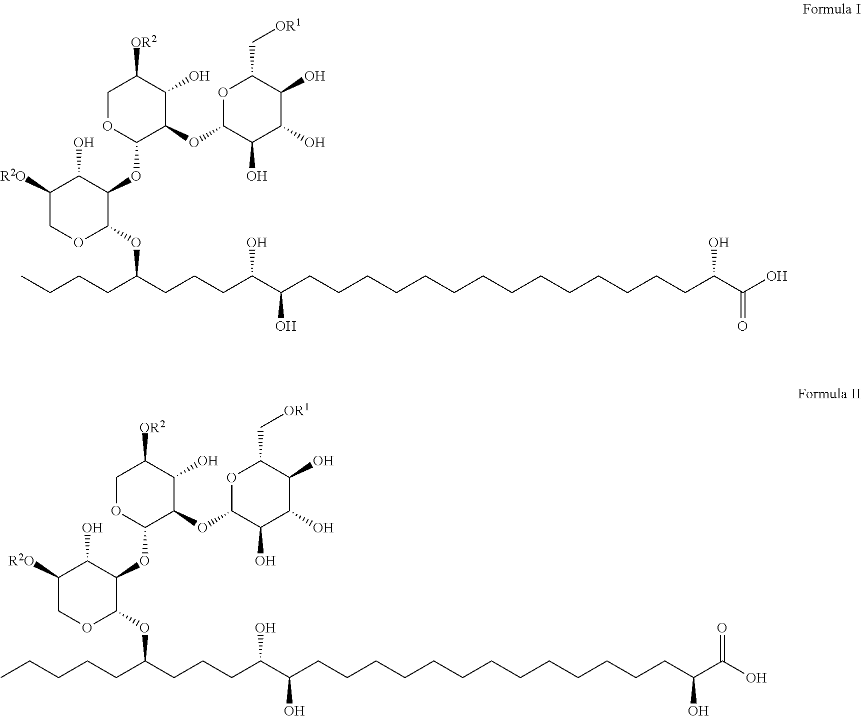

wherein R¹ is C(O)CH₃ or C(O)CH₂CH(CH₃)₂ and wherein R² is hydrogen or C(O)CH₃.

In some aspects, the powder base comprises from about 0.1 wt % to about 1 wt % of the glycolipid.

In some aspects, the polyphenol-containing substance is selected from the group consisting of whole apple extract, apricot extract, artichoke extract, asparagus extract, black bean extract, bitter almond extract, blackberry extract, blueberry extract, black currant extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof.

In some aspects, the powder base comprises from about 0.1 wt % to about 1 wt % of the polyphenol-containing substance.

In some aspects, the one or more acids is selected from the group consisting of ascorbic acid, citric acid, lactic acid, malic acid, tartaric acid, and combinations thereof.

In some aspects, the powder base comprises from about 10 wt % to about 50 wt % of the one or more acids.

In some aspects, the one or more bases is selected from the group consisting of potassium bicarbonate, potassium carbonate, sodium bicarbonate, sodium carbonate, potassium hydroxide, sodium hydroxide, and combinations thereof.

In some aspects, the powder base comprises from about 10 wt % to about 50 wt % of the one or more bases.

In some aspects, the powder base comprises from about 1 wt % to about 50 wt % collagen.

In some aspects, the present disclosure provides a beverage comprising water and:
a) collagen; and
b) one or both of:
   i) a polyphenol-containing substance, and
   ii) a glycolipid.

In some aspects, the glycolipid is selected from the group consisting of glycoglycerolipids, glycosphingolipids, sugar-linked sugar alcohol lipids. phosphoglycolipds, trehalose glycolipids, sophorose glycolipids, rhamnose glycolipids, phenolic glycoloipds, steryl glycolipids, and combinations thereof.

In some aspects, the glycoglycerolipids are selected from the group consisting of monoglycosyl diacylglycerol, diglycosyl diacylglycerol, triglycosyl diacylglycerol, aminoglycoglycerolipids, glucuronosylglycerolipids, sulfoglycoglycerolipds, and combinations thereof.

In some aspects, the glycosphingolipids are selected from the group consisting of cerebrosides, oligoglycosylceramides, sulfatides, gangliosides, and combinations thereof.

In some aspects, the sugar-linked sugar alcohol lipids are selected from the group consisting of mannosylerythritol lipids, acremomannolipin A, and a combination thereof.

In some aspects, the glycolipid is a compound of Formula I, Formula II, or a combination thereof:

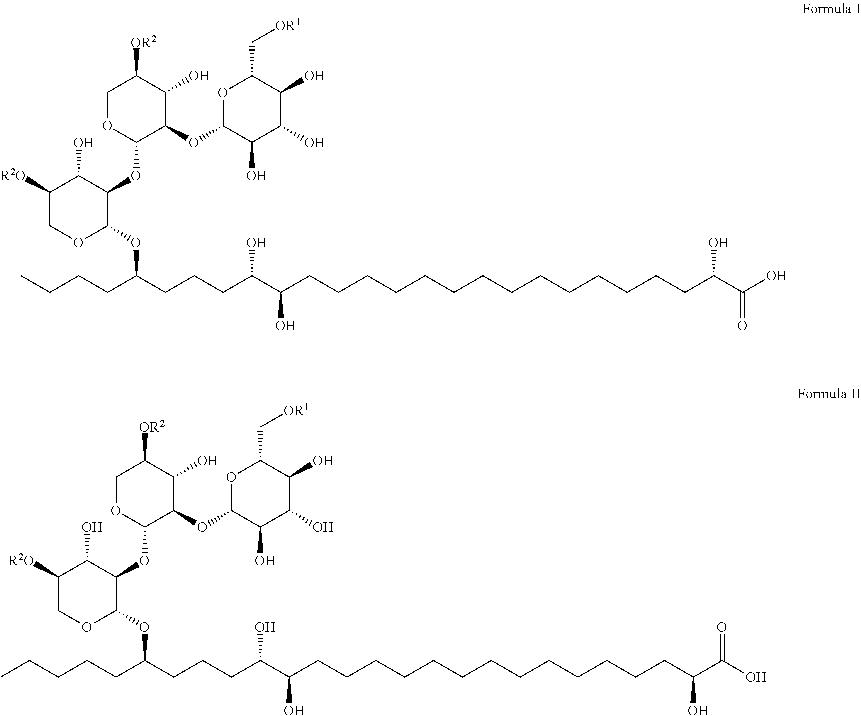

wherein R¹ is C(O)CH₃ or C(O)CH₂CH(CH₃)₂ and wherein R² is hydrogen or C(O)CH₃.

In some aspects, the beverage comprises from about 75 ppm to about 150 ppm of the glycloipid.

In some aspects, the polyphenol-containing substance is selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof.

In some aspects, the beverage comprises from about 75 ppm to about 150 ppm of the one or more polyphenol-containing substances.

In some aspects, the beverage comprises about 0.5 wt % to about 5 wt % of collagen.

In some aspects, the beverage further comprises one or more sweeteners.

In some aspects, the one or more sweeteners are selected from non-nutritive sweeteners, nutritive sweeteners, and combinations thereof.

In some aspects, the one or more non-nutritive sweeteners is selected from the group consisting of aspartame, acesulfame potassium, erythritol, xylitol, a steviol glycoside, and combinations thereof.

In some aspects, the steviol glycoside is selected from the group consisting of stevoside, steviolbioside, rubusoside, dulcoside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside Q, and combinations thereof.

In some aspects, the one or more nutritive sweeteners is selected from the group consisting of allulose, fructose, galactose, glucose, high fructose corn syrup lactose, maltose, maltulose, monk fruit extract, sucrose, and combinations thereof.

In some aspects, the nutritive sweetener is sucrose.

In some aspects, the beverage is a fountain beverage, a frozen beverage, a fruit juice, a fruit juice-flavored drink, a fruit-flavored drink, a cola beverage, a sports drink, an energy drink, a fortified/enhanced water drink, a flavored water, a soy drink, a vegetable drink, a grain-based drink, a malt beverage, a fermented drink, a yogurt drink, kefir, a coffee beverage, a tea beverage, a dairy beverage, a smoothie drink, a caffeinated energy drink, or an alcoholic beverage.

In some aspects, the present disclosure provides a method of preparing a beverage described above wherein the method comprises adding a powder base comprising:
a) collagen;
b) one or more acids;
c) one or more bases; and
d) one or both of:
   i) a polyphenol-containing substance, and
   ii) a glycolipid;
to water.

In some aspects, the glycolipid is selected from the group consisting of glycoglycerolipids, glycosphingolipids, sugar-linked sugar alcohol lipids. phosphoglycolipds, trehalose glycolipids, sophorose glycolipids, rhamnose glycolipids, phenolic glycoloipds, steryl glycolipids, and combinations thereof.

In some aspects, the glycoglycerolipids are selected from the group consisting of monoglycosyl diacylglycerol, diglycosyl diacylglycerol, triglycosyl diacylglycerol, aminoglycoglycerolipids, glucuronosylglycerolipids, sulfoglycoglycerolipds, and combinations thereof.

In some aspects, the glycosphingolipids are selected from the group consisting of cerebrosides, oligoglycosylceramides, sulfatides, gangliosides, and combinations thereof.

In some aspects, the sugar-linked sugar alcohol lipids are selected from the group consisting of mannosylerythritol lipids, acremomannolipin A, and a combination thereof.

In some aspects, the glycolipid is a compound of Formula I, Formula II, or a combination thereof:

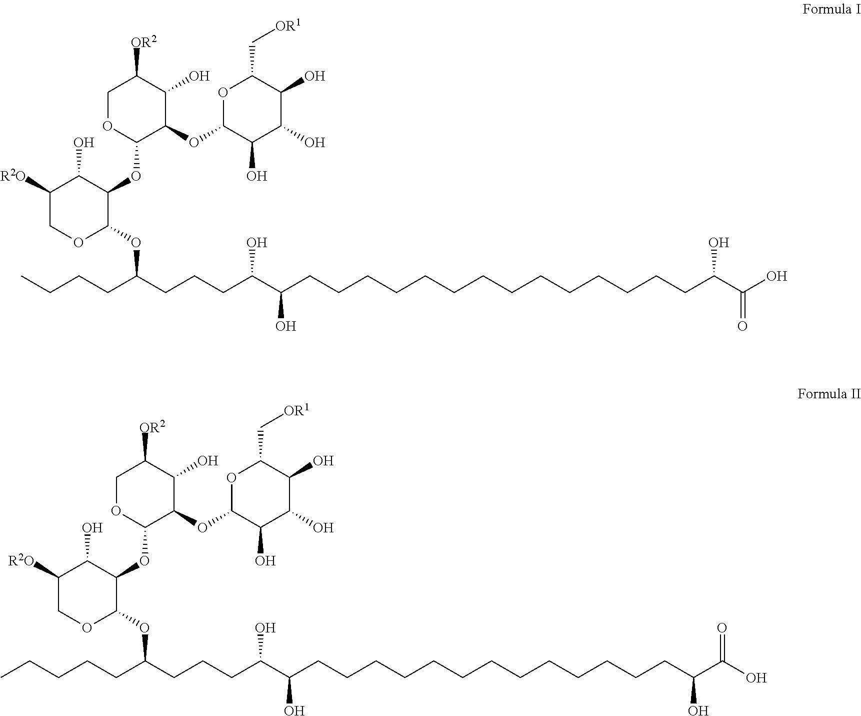

wherein R¹ is C(O)CH₃ or C(O)CH₂CH(CH₃)₂ and wherein R² is hydrogen or C(O)CH₃.

In some aspects, the powder base comprises from about 0.1 wt % to about 1 wt % of the glycolipid.

In some aspects, the polyphenol-containing substance is selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof.

In some aspects, the powder base comprises from about 0.1 wt % to about 1 wt % of the polyphenol-containing substance.

In some aspects, the one or more acids is selected from the group consisting of ascorbic acid, citric acid, lactic acid, malic acid, tartaric acid, and combinations thereof.

In some aspects, the powder base comprises from about 10 wt % to about 40 wt % of the one or more acids.

In some aspects, the one or more bases is selected from the group consisting of potassium bicarbonate, potassium carbonate, sodium bicarbonate, sodium carbonate, sodium hydroxide, and combinations thereof.

In some aspects, the powder base comprises from about 10 wt % to about 40 wt % of the one or more bases.

In some aspects, the powder base comprises from about 1 wt % to about 40 wt % collagen.

Additional aspects and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS/FIGURES

FIG. 1 shows the change in foam volume in time of collagen beverages having different degrees of sweetness (° Brix).

FIG. 2 shows the change in foam volume in time of collagen beverages containing whole apple extract.

FIG. 3 shows the change in foam volume in time of collagen beverages containing grape seed extract.

FIG. 4 shows the change in foam volume in time of collagen beverages containing Glycolipid mixture 1.

FIG. 5 shows the change in foam volume in time of collagen beverages containing Glycolipid mixture 1, whole apple extract, and grape seed extract.

FIG. 6 shows the change in foam volume in time of collagen beverages containing a mixture of whole apple extract and grape seed extract.

### DETAILED DESCRIPTION

The headings provided herein are not limitations of the various aspects of the disclosure, which can be defined by reference to the specification as a whole. It is also to be understood that the terminology used herein is for the purpose of describing particular aspects only, and is not intended to be limiting, since the scope of the present disclosure will be limited only by the appended claims.

### Definitions

For convenience, the meaning of some terms and phrases used in the specification, examples, and appended claims are provided below. Unless stated otherwise, or implicit from context, the following terms and phrases include the meanings provided below. The definitions are provided to aid in describing particular aspects, and are not intended to limit the claimed technology, because the scope of the technology is limited only by the claims. Unless otherwise defined, all technical and scientific terms used herein have the same meaning as commonly understood by one of ordinary skill in the art to which this technology belongs. If there is an apparent discrepancy between the usage of a term in the art and its definition provided herein, the definition provided within the specification will control.

The articles “a,” “an,” and “the” are used herein to refer to one or to more than one (i.e., to at least one) of the grammatical object of the article. By way of example, “an element” means one element or more than one element.

As used herein, the term “about” means within an acceptable error range for the particular value as determined by one of ordinary skill in the art, which depends in part on how the value is measured or determined, i.e., the limitations of the measurement system. For example, “about” can mean a range of up to 10% (e.g., up to 5% or up to 1%) of a given value.

The term “at least” prior to a number or series of numbers is understood to include the number associated with the term “at least,” and all subsequent numbers or integers that could logically be included, as clear from context. When at least is present before a series of numbers or a range, it is understood that “at least” modifies each of the numbers in the series or range. For example, “at least 3” means at least 3, at least 4, at least 5, etc. When at least is present before a component in a method step, then that component is included in the step, whereas additional components are optional.

As used herein, the term “collagen” refers to any food-safe collagen, including, but not limited to bovine collagen, porcine collagen, marine collagen, non-animal collagen, and combinations thereof. The term “non-animal collagen” refers to proteins that are similar to animal based collagens in their amino acid structures that are obtained through the precision fermentation technologies. The term collagen as used herein can also refer to food-safe collagen peptides prepared from the hydrolysis of bovine, porcine, marine, non-animal collagen, and any combination thereof.

As used herein, the terms “comprises,” “comprising,” “having,” “including,” “containing,” and the like are open-ended terms meaning “including, but not limited to.” To the extent a given aspect disclosed herein “comprises” certain elements, it should be understood that present disclosure also specifically contemplates and discloses aspects that “consist essentially of” those elements and that “consist of” those elements.

As used herein the terms “consists essentially of,” “consisting essentially of,” and the like are to be construed as a semi-closed terms, meaning that no other ingredients which materially affect the basic and novel characteristics of an aspect are included.

As used herein, the terms “consists of,” “consisting of,” and the like are to be construed as closed terms, such that an aspect “consisting of” a particular set of elements excludes any element, step, or ingredient not specified in the aspect.

As used herein, the term “glycolipid” refers to any compound containing one or more monosaccharide residues bound by a glycosidic linkage to a hydrophobic moiety.

### Compositions of the Disclosure

The present disclosure provides a ready-to-mix powder base containing collagen that can be added to a beverage (i.e., water, or any other beverage described herein) and provide certain foaming properties that can make the beverage more enjoyable to the consumer. Although collagen peptides are capable of capturing gas to generate a foam, they generally produce foams that collapse quickly. While sugars have been used to generate and stabilize foam beverages, the ready-to-mix powder base described herein allows for the formation of foaming beverages without high amounts of sugar. The powder base comprises collagen, one or more acids, one or more bases; and one or both of: a glycolipid and a polyphenol-containing substance.

Glycolipids can be derived from various sources, such as microbial, plant, animal, other biological sources, or synthetic sources. In some aspects, the glycolipids are selected from the group consisting of glycoglycerolipids, glycosphingolipids, sugar-linked sugar alcohol lipids, phosphoglycolipds, trehalose glycolipids (trehalose lipids), sophorose glycolipids (sophorolipids), rhamnose glycolipids (rhamnolipids), phenolic glycolipids (phenolic glycosides), steryl glycolipids (steryl glycosides), and combinations thereof.

Examples of glycoglycerolipds include, but are not limited to, monoglycosyl diacylglycerol, diglycosyl diacylglycerol, triglycosyl diacylglycerol, aminoglycoglycerolipids, glucuronosylglycerolipids, and sulfoglycoglycerolipds. In some aspects, the glycolipids comprise a glycoglycerolipid selected from the group consisting of monoglycosyl diacylglycerol, diglycosyl diacylglycerol, triglycosyl diacylglycerol, aminoglycoglycerolipids, glucuronosylglycerolipids, sulfoglycoglycerolipds, and combinations thereof.

Examples of glycosphingolipids include, but are not limited to, cerebrosides, oligoglycosylceramides, sulfatides, and gangliosides. In some aspects, the glycolipids comprise a glycosphingolipid selected from the group consisting of cerebrosides, oligoglycosylceramides, sulfatides, gangliosides, and combinations thereof.

Examples of sugar-linked sugar alcohol lipids include, but are not limited to, mannosylerythritol lipids and acremomannolipin A. In some aspects, the glycolipids comprise a sugar-linked sugar alcohol lipid selected from the group consisting of mannosylerythritol lipids, acremomannolipin A, and a combination thereof.

In some aspects, the glycolipids are derived from the fungus Dacryopinax spathularia. Glucose fermentation by fungus Dacryopinax spathularia provides natural glycolipids that can be categorized into long-chain glycolipids having a structure of formula (I) or (II):

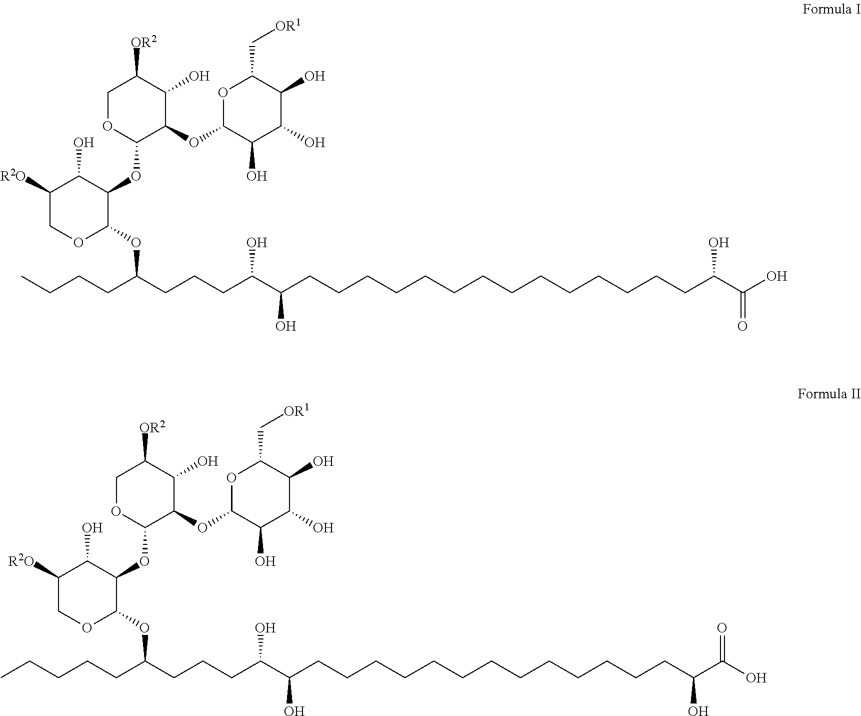

wherein R¹ is C(O)CH₃ or C(O)CH₂CH(CH₃)₂ and wherein R² is hydrogen or C(O)CH₃.

In some aspects, the glycolipids comprise a compound of formula (I) or formula (II). In some aspects, the glycolipids comprise a compound selected from the group consisting of:

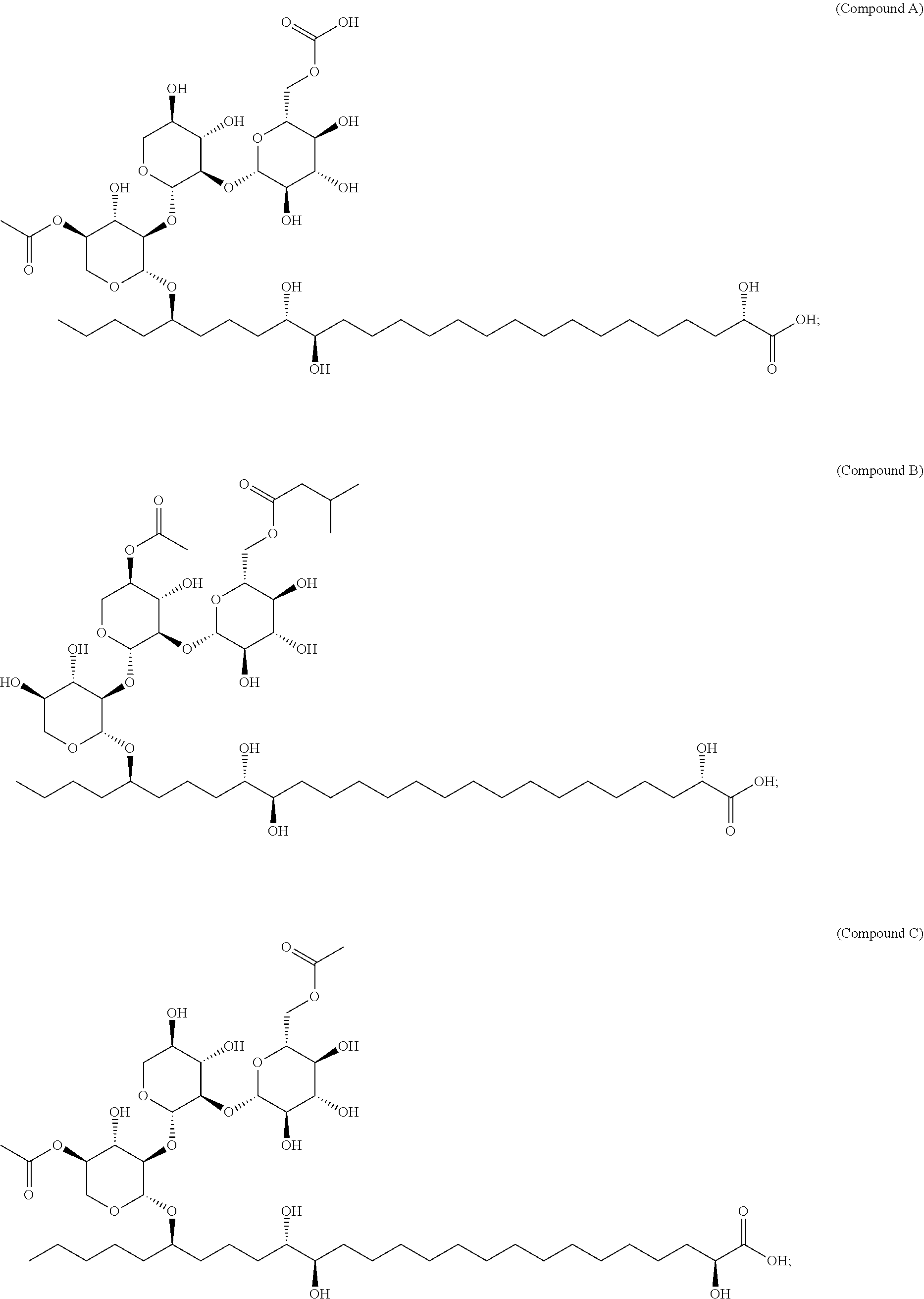

and combinations thereof.

In some aspects, the glycolipids comprise a combination of Compound A, Compound B, and Compound C (“Glycolipid Mixture 1”). In some aspects, the weight ratio of Compound A to Compound B in Glycolipid Mixture 1 is from about 1:99 to about 99:1, from about 10:90 to about 90:10, from about 20:80 to about 80:20, from about 30:70 to about 70:30, from about 40:60 to about 60:40, or is about 50:50.

In some aspects, the weight ratio of Compound B to Compound C in Glycolipid Mixture 1 is from about 1:99 to about 99:1, from about 10:90 to about 90:10, from about 20:80 to about 80:20, from about 30:70 to about 70:30, from about 40:60 to about 60:40, or is about 50:50

In some aspects, the weight ratio of Compound A to Compound B in Glycolipid Mixture 1 is from about 1:99 to about 99:1 and the weight ratio of Compound B to Compound C in the mixture is from about 1:99 and about 99:1. In some aspects, the weight ratio of Compound A to Compound B in the mixture is from about 10:90 to about 90:10 and the weight ratio of Compound B to Compound C in the mixture is from about 10:90 and about 90:10. In some aspects, the weight ratio of Compound A to Compound B in the mixture is from about 20:80 to about 80:20 and the weight ratio of Compound B to Compound C in the mixture is from about 20:80 to about 80:20. In some aspects, the weight ratio of Compound A to Compound B in the mixture is from about 30:70 to about 70:30 and the weight ratio of Compound B to Compound C in the mixture is from about 30:70 and about 70:30. In some aspects, the weight ratio of Compound A to Compound B in the mixture is from about 40:60 to about 60:40 and the weight ratio of Compound B to Compound C in the mixture is from about 40:60 and about 60:40. In some aspects, the weight ratio of Compound A to Compound B in the mixture is about 50:50 and the weight ratio of Compound B to Compound C in the mixture is about 50:50.

In some aspects, the glycolipids comprise the glycolipids of Glycolipid Mixture 1 which comprises Compound A, Compound B, and Compound C in ratios found in the fungus Dacryopinax spathularia.

In some aspects, the glycolipids added to the powder base are added in an amount sufficient to be present in the powder base at a concentration of from about 0.1 wt % to about 10 wt %. In some aspects, the one or more glycolipids added to the powder base are added in an amount sufficient to be present in the powder base at a concentration of from about 0.1 wt % to about 8 wt %. In some aspects, the one or more glycolipids added to the powder base are added in an amount sufficient to be present in the powder base at a concentration of from about 0.1 wt % to about 6 wt %. In some aspects, the one or more glycolipids added to the powder base are added in an amount sufficient to be present in the powder base at a concentration of from about 0.1 wt % to about 4 wt %. In some aspects, the one or more glycolipids added to the powder base are added in an amount sufficient to be present in the powder base at a concentration of from about 0.1 wt % to about 2 wt %. In some aspects, the one or more glycolipids added to the powder base are added in an amount sufficient to be present in the powder base at a concentration of from about 0.1 wt % to about 1 wt %. In some aspects, the one or more glycolipids added to the powder base are added in an amount sufficient to be present in the powder base at a concentration of from about 0.1 wt % to about 0.9 wt %. In some aspects, the one or more glycolipids added to the powder base are added in an amount sufficient to be present in the powder base at a concentration of from about 0.1 wt % to about 0.8 wt %. In some aspects, the one or more glycolipids added to the powder base are added in an amount sufficient to be present in the powder base at a concentration of from about 0.1 wt % to about 0.7 wt %. In some aspects, the one or more glycolipids added to the powder base are added in an amount sufficient to be present in the powder base at a concentration of from about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt % about 2.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt %.

In some aspects, the powder base comprises, in addition to the glycolipids described above or as an alternative to the glycolipids described above, one or more polyphenol-containing substances. Examples of polyphenol-containing substances include, but are not limited to, whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof. The extracts can be from any part of the substance (i.e., skin, inner portion, seed). In addition, the extract can be obtained from any breed or life-cycle of the agent (e.g, green apple, red apple, Himilayan blackberry, Evergreen blackberry, rabbiteye blueberry, lowbush blueberry, everbearing strawberries, day-neutral strawberries, ripened or unripened substances, etc.). In some aspects, the one or more polyphenol-containing compounds can be whole apple extract. In some aspects, the one or more polyphenol-containing compounds can be grape seed extract. In some aspects, the one or more polyphenol-containing compounds can be a mixture of whole apple extract and grape seed extract.

In some aspects, the one or more polyphenol-containing compounds added to the powder base are added in an amount sufficient to be present in the powder base at a concentration of from about 0.1 wt % to about 10 wt %. In some aspects, the one or more polyphenol-containing compounds added to the powder base are added in an amount sufficient to be present in the powder base at a concentration of from about 0.1 wt % to about 8 wt %. In some aspects, the one or more polyphenol-containing compounds added to the powder base are added in an amount sufficient to be present in the powder base at a concentration of from about 0.1 wt % to about 6 wt %. In some aspects, the one or more polyphenol-containing compounds added to the powder base are added in an amount sufficient to be present in the powder base at a concentration of from about 0.1 wt % to about 4 wt %. In some aspects, the one or more polyphenol-containing compounds added to the powder base are added in an amount sufficient to be present in the powder base at a concentration of from about 0.1 wt % to about 2 wt %. In some aspects, the one or more polyphenol-containing compounds added to the powder base are added in an amount sufficient to be present in the powder base at a concentration of from about 0.1 wt % to about 1 wt %. In some aspects, the one or more polyphenol-containing compounds added to the powder base are added in an amount sufficient to be present in the powder base at a concentration of from about 0.1 wt % to about 0.9 wt %. In some aspects, the one or more polyphenol-containing compounds added to the powder base are added in an amount sufficient to be present in the powder base at a concentration of from about 0.1 wt % to about 0.8 wt %. In some aspects, the one or more polyphenol-containing compounds added to the powder base are added in an amount sufficient to be present in the powder base at a concentration of from about 0.1 wt % to about 0.7 wt %. In some aspects, the one or more polyphenol-containing compounds added to the powder base are added in an amount sufficient to be present in the powder base at a concentration of from about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt % about 2.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt %.

In some aspects, the powder base can comprise a glycolipid and one or more polyphenol-containing substances. In some aspects, the powder base can comprise from about 0.1 wt % to about 10 wt % of a glycolipid and about 0.1 wt % to about 10 wt % of one or more polyphenol-containing compounds. In some aspects, the powder base can comprise from about 0.1 wt % to about 10 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof, and about 0.1 wt % to about 10 wt % of one or more polyphenol-containing compounds selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof.

In some aspects, the powder base can comprise one or more acids. In some aspects, the one or more acids is a solid acid, i.e. an acid that is a solid at standard temperature and pressure. Examples of solid acids include, but are not limited to, ascorbic acid, citric acid, lactic acid, malic acid, tartaric acid, and combinations thereof. In some aspects, the one or more acids comprises citric acid.

In some aspects, the powder base comprises from about 10 wt % to about 50 wt %, from about 15 wt % to about 45 wt %, from about 20 wt % to about 40 wt %, or from about 25 wt % to about 35 wt % of one or more acids, typically a solid acid as described above, such as citric acid, relative to the weight of the powder base. In some aspects, the powder base comprises about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 w %, about 48 wt %, about 49 wt %, or about 50 wt % of one or more acids relative to the weight of the powder base. In particular embodiments, the powder base comprises about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 w %, about 48 wt %, about 49 wt %, or about 50 wt % of one or more solid acids.

In some aspects, the powder base comprises from about 10 wt % to about 50 wt %, from about 15 wt % to about 45 wt %, from about 20 wt % to about 40 wt %, or from about 25 wt % to about 35 wt % of a solid acid selected from the group consisting of ascorbic acid, citric acid, lactic acid, malic acid, tartaric acid, and combinations thereof, relative to the weight of the powder base. In some aspects, the powder base comprises about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 w %, about 48 wt %, about 49 wt %, or about 50 wt % of a solid acid selected from the group consisting of ascorbic acid, citric acid, lactic acid, malic acid, tartaric acid, and combinations thereof, relative to the weight of the powder base.

In some aspects, the powder base can comprise one or more bases. Typically, the base and the acid are present in the formulation so that when the powder base is added to a beverage, i.e. water, the acid and base react to form a foam. In some aspects, the one or more bases is a solid base. Examples of solid bases include, but are not limited to, potassium bicarbonate, potassium carbonate, sodium bicarbonate, sodium carbonate, sodium hydroxide, and combinations thereof. In some aspects, the one or more acids comprises sodium bicarbonate.

In some aspects, the powder base comprises from about 10 wt % to about 50 wt %, from about 15 wt % to about 45 wt %, from about 20 wt % to about 40 wt %, or from about 25 wt % to about 35 wt % of one or more bases relative to the weight of the powder base. In some aspects, the powder base comprises about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 w %, about 48 wt %, about 49 wt %, or about 50 wt % of one or more bases relative to the weight of the powder base.

In some aspects, the powder base comprises from about 10 wt % to about 50 wt %, from about 15 wt % to about 45 wt %, from about 20 wt % to about 40 wt %, or from about 25 wt % to about 35 wt % of a base selected from the group consisting of potassium bicarbonate, potassium carbonate, sodium bicarbonate, sodium carbonate, sodium hydroxide, and combinations thereof, relative to the weight of the powder base. In some aspects, the powder base comprises about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 w %, about 48 wt %, about 49 wt %, or about 50 wt % of a base selected from the group consisting of potassium bicarbonate, potassium carbonate, sodium bicarbonate, sodium carbonate, sodium hydroxide, and combinations thereof, relative to the weight of the powder base.

The powder base described herein typically comprises a glycolipid and/or a polyphenol of the varying types and in the amounts described above, an acid typically present as a solid of the varying types and in the amounts described above, a base of the varying types and in the amounts described above, and also comprises collagen. In some aspects, the powder base comprises bovine collagen, porcine collagen, marine collagen, or combinations thereof.

In some aspects, the powder base comprises from about 1 wt % to about 50 wt %, from about 5 wt % to about 50 wt %, from about 10 wt % to about 50 wt %, from about 20 wt % to about 50 wt %, or from about 30 wt % to about 50 wt % of bovine collagen, porcine collagen, marine collagen, or combinations thereof relative to the weight of the powder base. In some aspects, the powder base comprises about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 w %, about 48 wt %, about 49 wt %, or about 50 wt % of bovine collagen, porcine collagen, marine collagen, or combinations thereof relative to the weight of the powder base.

In some aspects, the powder base comprises from about 1 wt % to about 50 wt %, from about 5 wt % to about 50 wt %, from about 10 wt % to about 50 wt %, from about 20 wt % to about 50 wt %, or from about 30 wt % to about 50 wt % of bovine collagen, relative to the weight of the powder base. In some aspects, the powder base comprises about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 w %, about 48 wt %, about 49 wt %, or about 50 wt % of bovine collagen, relative to the weight of the powder base.

In certain aspects, the powder base comprises a glycolipid and/or a polyphenol of the varying types and in the amounts described above, an acid typically present as a solid of the varying types and in the amounts described above, a base of the varying types and in the amounts described above, collagen of the varying types and in the amounts described above, and does not comprise any additional sweeteners.

In certain aspects, the powder base comprises a glycolipid and/or a polyphenol of the varying types and in the amounts described above, an acid typically present as a solid of the varying types and in the amounts described above, a base of the varying types and in the amounts described above, collagen of the varying types and in the amounts described above, and also comprises one or more added sweeteners. In some aspects, the added sweeteners are selected from the group consisting of nutritive sweeteners, non-nutritive sweeteners, and combinations thereof.

In some aspects, the powder base comprises an amount of added sweetener sufficient to provide a beverage having a level of sweetness of, or equivalent to, about 1 Brix to about 11 Brix. In some aspects, the powder base comprises an amount of added sweetener sufficient to provide a beverage having a level of sweetness of, or equivalent to, about 1, about 2, about 3, about 4, about 5, about 6, about 7, about 8, about 9, about 10, or about 11 Brix.

In some aspects, the one or more added sweeteners comprises one or more nutritive sweeteners. Examples of nutritive sweeteners include, but are not limited to, allulose, fructose, galactose, glucose, high fructose corn syrup, lactose, maltose, maltulose, sucrose. In some aspects, the one or more nutritive sweeteners is selected from the group consisting of allulose, fructose, galactose, glucose, high fructose corn syrup lactose, maltose, maltulose, sucrose, and combinations thereof. In some aspects the one or more nutritive sweeteners can be sucrose, glucose, fructose, or a mixture thereof. In some aspects, the powder base comprises from about 1 wt % to about 85 wt %, from about 1 wt % to about 75 wt %, from about 1 wt % to about 65 wt %, from about 1 wt % to about 55 wt %, from about 1 wt % to about 45 wt %, from about 1 wt % to about 35 wt %, from about 1 wt % to about 25 wt %, or from about 1 wt % to about 15 wt %, of one or more added nutritive sweeteners selected from the group consisting of allulose, fructose, galactose, glucose, high fructose corn syrup lactose, maltose, maltulose, sucrose, and combinations thereof, relative to the total weight of the powder base. In some aspects, the powder base comprises about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 0.3 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, or about 85 wt % of one or more nutritive sweeteners selected from the group consisting of allulose, fructose, galactose, glucose, high fructose corn syrup lactose, maltose, maltulose, sucrose, and combinations thereof, relative to the total weight of the powder base.

In some aspects, the powder base comprises a glycolipid and/or a polyphenol of the varying types and in the amounts described above, an acid typically present as a solid of the varying types and in the amounts described above, a base of the varying types and in the amounts described above, collagen of the varying types and in the amounts described above, and also comprises sufficient amount of one or more added nutritive sweeteners to prepare a beverage comprising from about 0.5 wt % to about 10 wt %, from about 0.5 wt % to about 5 wt %, from about 0.75 wt % to about 4.5 wt %, from about 1 wt % to about 4 wt %, or from about 1.5 wt % to about 3.5 wt %, of the one or more nutritive sweeteners selected from the group consisting of allulose, fructose, galactose, glucose, high fructose corn syrup lactose, maltose, maltulose, sucrose, and combinations thereof. In some aspects, the powder base comprises about 0.5 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.5 wt %, about 4 wt %, or about 5 wt % of the one or more nutritive sweeteners selected from the group consisting of allulose, fructose, galactose, glucose, high fructose corn syrup lactose, maltose, maltulose, sucrose, and combinations thereof.

In some aspects, the powder base comprises a glycolipid and/or a polyphenol of the varying types and in the amounts described above, an acid typically present as a solid of the varying types and in the amounts described above, a base of the varying types and in the amounts described above, collagen of the varying types and in the amounts described above, and also comprises one or more non-nutritive sweeteners. Examples of non-nutritive sweeteners include, but are not limited to, aspartame, acesulfame potassium, erythritol, neotame, saccharin, sucralose, xylitol, monk fruit, and a steviol glycoside. In some aspects, the one or more non-nutritive sweeteners is selected from the group consisting of aspartame, acesulfame potassium, erythritol, neotame, saccharin, sucralose, xylitol, a steviol glycoside, and combinations thereof.

Suitable steviol glycosides include, but are not limited to, rebaudioside A (Reb A), rebaudioside B (Reb B), rebaudioside C (Reb C), rebaudioside D (Reb D), rebaudioside E (Reb E), rebaudioside F (Reb F), rebaudioside G (Reb G), rebaudioside I (Reb I), rebaudioside J (Reb J), rebaudioside KA (Reb KA), rebaudioside M (Reb M), rebaudioside V (Reb V), rebaudioside W (Reb W), steviolbioside, stevioside, rubusoside, and dulcoside A. The steviol glycoside can be used singly or as a mixture of two or more. In certain aspects, the steviol glycoside can be a complex between rebaudioside D and Stevioside such as disclosed and described in U.S. Pat. No. 11,998,033, the entirety of which is incorporated herein by reference.

In some aspects, the non-nutritive sweetener can be a steviol glycoside. In some aspects, the steviol glycoside can be stevioside, dulcoside, rebaudioside A, rebaudioside B, rebaudioside C, rebaudioside D, rebaudioside E, rebaudioside F, rebaudioside M, or any combination thereof. In some aspects, the steviol glycoside can be rebaudioside A (e.g., Reb A 98, which is rebaudioside A with 98% purity), rebaudioside D (e.g., Reb D 95, which is rebaudioside D with 95% purity), rebaudioside M (e.g., Reb M 99, which is rebaudioside M with 99% purity), or any combination thereof. In some aspects, the steviol glycoside can be rebaudioside A. In some aspects, the steviol glycoside can be rebaudioside D. In some aspects, the steviol glycoside can be rebaudioside M. In some aspects, the powder base can comprise a combination of rebaudioside A and rebaudioside D. In some aspects, the powder base can comprise a combination of rebaudioside A and rebaudioside M. In some aspects, the powder base can comprise a combination of rebaudioside D and rebaudioside M. In some aspects, the powder base can comprise a combination of rebaudioside A, rebaudioside D, and rebaudioside M. In any of these aspects, the powder base can further comprise erythritol (e.g., a combination of erythritol and at least one steviol glycoside, such as a combination of erythritol and Reb A, erythritol and Reb D, erythritol and Reb M, erythritol in combination with Reb A and Reb D, erythritol in combination with Reb A and Reb M, erythritol in combination with Reb D and Reb M, or erythritol in combination with Reb A, Reb D, and Reb M).

In some aspects, the powder base comprises from about 0.05 wt % to about 5 wt % of one or more non-nutritive sweeteners. In some aspects, the powder base comprises from about 0.05 wt % to about 4.5 wt % of one or more non-nutritive sweeteners. In some aspects, the powder base comprises from about 0.05 wt % to about 4 wt % of one or more non-nutritive sweeteners. In some aspects, the powder base comprises from about 0.05 wt % to about 3.5 wt % of one or more non-nutritive sweeteners. In some aspects, the powder base comprises from about 0.05 wt % to about 3 wt % of one or more non-nutritive sweeteners. In some aspects, the powder base comprises from about 0.05 wt % to about 2.5 wt % of one or more non-nutritive sweeteners. In some aspects, the powder base comprises from about 0.05 wt % to about 2 wt % of one or more non-nutritive sweeteners. In some aspects, the powder base comprises from about 0.05 wt % to about 1.5 wt % of one or more non-nutritive sweeteners. In some aspects, the powder base comprises from about 0.05 wt % to about 1 wt % of one or more non-nutritive sweeteners. In some aspects, the powder base comprises about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt % about 2.5 wt %, about 4 wt %, about 4.5 wt %, or about 5 wt % of one or more non-nutritive sweeteners.

In some aspects, the powder base comprises from about 0.05 wt % to about 5 wt % of rebaudioside A, rebaudioside M, rebaudioside D, or a combination thereof. In some aspects, the powder base comprises from about 0.05 wt % to about 4.5 wt % of rebaudioside A, rebaudioside M, rebaudioside D, or a combination thereof. In some aspects, the powder base comprises from about 0.05 wt % to about 4 wt % of rebaudioside A, rebaudioside M, rebaudioside D, or a combination thereof. In some aspects, the powder base comprises from about 0.05 wt % to about 3.5 wt % of rebaudioside A, rebaudioside M, rebaudioside D, or a combination thereof. In some aspects, the powder base comprises from about 0.05 wt % to about 3 wt % of rebaudioside A, rebaudioside M, rebaudioside D, or a combination thereof. In some aspects, the powder base comprises from about 0.05 wt % to about 2.5 wt % of rebaudioside A, rebaudioside M, rebaudioside D, or a combination thereof. In some aspects, the powder base comprises from about 0.05 wt % to about 2 wt % of rebaudioside A, rebaudioside M, rebaudioside D, or a combination thereof. In some aspects, the powder base comprises from about 0.05 wt % to about 1.5 wt % of rebaudioside A, rebaudioside M, rebaudioside D, or a combination thereof. In some aspects, the powder base comprises from about 0.05 wt % to about 1 wt % of rebaudioside A, rebaudioside M, rebaudioside D, or a combination thereof. In some aspects, the powder base comprises about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt % about 2.5 wt %, about 4 wt %, about 4.5 wt %, or about 5 wt % of rebaudioside A, rebaudioside M, rebaudioside D, or a combination thereof.

In some aspects, the powder base comprises a sufficient amount of non-nutritive sweetener such that a beverage prepared from a unit dose of the powder base contains an non-nutritive sweetener ranging from a given sweetener's taste recognition threshold concentration to about 1000 ppm. In some aspects, the unit dose comprises from about 4 g to about 5 g of powder base in from about 200 mL to about 300 mL of a liquid. In some aspects, the unit dose comprises from about 4 g to about 4.5 g of powder base in from about 200 mL to about 250 mL of a liquid. In some aspects, the unit dose comprises about 4.3 g of powder base in about 220 mL of a liquid. In other aspects, the powder base comprises an amount of non-nutritive sweetener sufficient to provide a beverage comprising from about 10 ppm to about 1000 ppm, from about 10 ppm to about 750 ppm, from about 10 ppm to about 500 ppm, from about 10 ppm to about 450 ppm, from about 10 ppm to about 400 ppm, or from about 10 ppm to about 300 ppm, of the one or more non-nutritive sweeteners. In some aspects, the powder base comprises about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 70 ppm, about 75 ppm, about 80 ppm, about 90 ppm, about 95 ppm, about 100 ppm, about 105 ppm, about 110 ppm, about 120 ppm, about 125 ppm, about 130 ppm, about 135 ppm, about 140 ppm, about 145 ppm, about 150 ppm, about 155 ppm, about 160 ppm, about 170 ppm, about 175 ppm, about 180 ppm, about 190 ppm, about 200 ppm, about 205 ppm, about 210 ppm, about 220 ppm, about 225 ppm, about 230 ppm, about 235 ppm, about 240 ppm, about 245 ppm, about 250 ppm, about 255 ppm, about 260 ppm, about 270 ppm, about 275 ppm, about 280 ppm, about 290 ppm, about 300 ppm, about 305 ppm, about 310 ppm, about 320 ppm, about 325 ppm, about 330 ppm, about 335 ppm, about 340 ppm, about 345 ppm, about 350 ppm, about 355 ppm, about 360 ppm, about 370 ppm, about 375 ppm, about 380 ppm, about 390 ppm, about 400 ppm, about 405 ppm, about 410 ppm, about 420 ppm, about 425 ppm, about 430 ppm, about 435 ppm, about 440 ppm, about 445 ppm, about 450 ppm, about 455 ppm, about 460 ppm, about 470 ppm, about 475 ppm, about 480 ppm, about 490 ppm, about 500 ppm, about 505 ppm, about 510 ppm, about 520 ppm, about 525 ppm, about 530 ppm, about 535 ppm, about 540 ppm, about 545 ppm, about 550 ppm, about 555 ppm, about 560 ppm, about 570 ppm, about 575 ppm, about 580 ppm, about 590 ppm, about 600 ppm, about 605 ppm, about 610 ppm, about 620 ppm, about 625 ppm, about 630 ppm, about 635 ppm, about 640 ppm, about 645 ppm, about 650 ppm, about 655 ppm, about 660 ppm, about 670 ppm, about 675 ppm, about 680 ppm, about 690 ppm, about 700 ppm, about 705 ppm, about 710 ppm, about 720 ppm, about 725 ppm, about 730 ppm, about 735 ppm, about 740 ppm, about 745 ppm, or about 750 ppm of one or more non-nutritive sweeteners.

In some aspects, the powder base comprises an amount of rebaudioside A, rebaudioside M, rebaudioside D, or a combination thereof, ranging from a given sweetener's taste recognition threshold concentration to about 1000 ppm. In other aspects, the powder base comprises an amount of rebaudioside A, rebaudioside M, rebaudioside D, or a combination thereof, ranging from about 10 ppm to about 1000 ppm, or from about 10 ppm to about 750 ppm, from about 10 ppm to about 500 ppm, from about 10 ppm to about 450 ppm, from about 10 ppm to about 400 ppm, or from about 10 ppm to about 300 ppm, of rebaudioside A, rebaudioside M, rebaudioside D, or a combination thereof. In some aspects, the powder base comprises about 10 ppm, about 20 ppm, about 25 ppm, about 30 ppm, about 35 ppm, about 40 ppm, about 45 ppm, about 50 ppm, about 55 ppm, about 60 ppm, about 70 ppm, about 75 ppm, about 80 ppm, about 90 ppm, about 95 ppm, about 100 ppm, about 105 ppm, about 110 ppm, about 120 ppm, about 125 ppm, about 130 ppm, about 135 ppm, about 140 ppm, about 145 ppm, about 150 ppm, about 155 ppm, about 160 ppm, about 170 ppm, about 175 ppm, about 180 ppm, about 190 ppm, about 200 ppm, about 205 ppm, about 210 ppm, about 220 ppm, about 225 ppm, about 230 ppm, about 235 ppm, about 240 ppm, about 245 ppm, about 250 ppm, about 255 ppm, about 260 ppm, about 270 ppm, about 275 ppm, about 280 ppm, about 290 ppm, about 300 ppm, about 305 ppm, about 310 ppm, about 320 ppm, about 325 ppm, about 330 ppm, about 335 ppm, about 340 ppm, about 345 ppm, about 350 ppm, about 355 ppm, about 360 ppm, about 370 ppm, about 375 ppm, about 380 ppm, about 390 ppm, about 400 ppm, about 405 ppm, about 410 ppm, about 420 ppm, about 425 ppm, about 430 ppm, about 435 ppm, about 440 ppm, about 445 ppm, about 450 ppm, about 455 ppm, about 460 ppm, about 470 ppm, about 475 ppm, about 480 ppm, about 490 ppm, about 500 ppm, about 505 ppm, about 510 ppm, about 520 ppm, about 525 ppm, about 530 ppm, about 535 ppm, about 540 ppm, about 545 ppm, about 550 ppm, about 555 ppm, about 560 ppm, about 570 ppm, about 575 ppm, about 580 ppm, about 590 ppm, about 600 ppm, about 605 ppm, about 610 ppm, about 620 ppm, about 625 ppm, about 630 ppm, about 635 ppm, about 640 ppm, about 645 ppm, about 650 ppm, about 655 ppm, about 660 ppm, about 670 ppm, about 675 ppm, about 680 ppm, about 690 ppm, about 700 ppm, about 705 ppm, about 710 ppm, about 720 ppm, about 725 ppm, about 730 ppm, about 735 ppm, about 740 ppm, about 745 ppm, or about 750 ppm of the rebaudioside A, rebaudioside M, rebaudioside D, or the combination thereof.

In some aspects, the powder base comprises an amount of rebaudioside A, rebaudioside M, rebaudioside D, or a combination thereof, sufficient to provide a beverage having an amount ranging from a given sweetener's taste recognition threshold concentration to about 1000 ppm. In other aspects, the powder base comprises an amount of rebaudioside A, rebaudioside M, rebaudioside D, or a combination thereof, sufficient to provide a beverage comprising from about 10 ppm to about 1000 ppm, or from about 10 ppm to about 750 ppm, from about 10 ppm to about 500 ppm, from about 10 ppm to about 450 ppm, from about 10 ppm to about 400 ppm, or from about 10 ppm to about 300 ppm, of the rebaudioside A, rebaudioside M, rebaudioside D, or the combination thereof. In some aspects, the powder base comprises about 10 ppm, about 20 ppm, about 25 ppm, about 30 ppm, about 35 ppm, about 40 ppm, about 45 ppm, about 50 ppm, about 55 ppm, about 60 ppm, about 70 ppm, about 75 ppm, about 80 ppm, about 90 ppm, about 95 ppm, about 100 ppm, about 105 ppm, about 110 ppm, about 120 ppm, about 125 ppm, about 130 ppm, about 135 ppm, about 140 ppm, about 145 ppm, about 150 ppm, about 155 ppm, about 160 ppm, about 170 ppm, about 175 ppm, about 180 ppm, about 190 ppm, about 200 ppm, about 205 ppm, about 210 ppm, about 220 ppm, about 225 ppm, about 230 ppm, about 235 ppm, about 240 ppm, about 245 ppm, about 250 ppm, about 255 ppm, about 260 ppm, about 270 ppm, about 275 ppm, about 280 ppm, about 290 ppm, about 300 ppm, about 305 ppm, about 310 ppm, about 320 ppm, about 325 ppm, about 330 ppm, about 335 ppm, about 340 ppm, about 345 ppm, about 350 ppm, about 355 ppm, about 360 ppm, about 370 ppm, about 375 ppm, about 380 ppm, about 390 ppm, about 400 ppm, about 405 ppm, about 410 ppm, about 420 ppm, about 425 ppm, about 430 ppm, about 435 ppm, about 440 ppm, about 445 ppm, about 450 ppm, about 455 ppm, about 460 ppm, about 470 ppm, about 475 ppm, about 480 ppm, about 490 ppm, about 500 ppm, about 505 ppm, about 510 ppm, about 520 ppm, about 525 ppm, about 530 ppm, about 535 ppm, about 540 ppm, about 545 ppm, about 550 ppm, about 555 ppm, about 560 ppm, about 570 ppm, about 575 ppm, about 580 ppm, about 590 ppm, about 600 ppm, about 605 ppm, about 610 ppm, about 620 ppm, about 625 ppm, about 630 ppm, about 635 ppm, about 640 ppm, about 645 ppm, about 650 ppm, about 655 ppm, about 660 ppm, about 670 ppm, about 675 ppm, about 680 ppm, about 690 ppm, about 700 ppm, about 705 ppm, about 710 ppm, about 720 ppm, about 725 ppm, about 730 ppm, about 735 ppm, about 740 ppm, about 745 ppm, or about 750 ppm of the rebaudioside A, rebaudioside M, rebaudioside D, or the combination thereof.

In some aspects, the powder base comprises one or more nutritive sweeteners and one or more non-nutritive sweeteners. In some aspects, the powder base comprises from about 1 wt % to about 85 wt % of one or more nutritive sweeteners and from about 0.05 wt % to about 5 wt % of one or more non-nutritive sweeteners.

In some aspects, the powder base comprises from about 1 wt % to about 85 wt % of one or more nutritive sweeteners selected from the group consisting of allulose, fructose, galactose, glucose, high fructose corn syrup, lactose, maltose, maltulose, sucrose. In some aspects, the one or more nutritive sweeteners is selected from the group consisting of allulose, fructose, galactose, glucose, high fructose corn syrup, lactose, maltose, maltulose, sucrose, and combinations thereof and from about 0.05 wt % to about 5 wt % of one or more non-nutritive sweeteners selected from the group consisting of aspartame, acesulfame potassium, erythritol, neotame, saccharin, sucralose, xylitol, monk fruit, and a steviol glycoside. In some aspects, the one or more non-nutritive sweeteners is selected from the group consisting of aspartame, acesulfame potassium, erythritol, neotame, saccharin, sucralose, xylitol, a steviol glycoside, and combinations thereof.

In some aspects, the powder base comprises from about 1 wt % to about 85 wt % of one or more nutritive sweeteners selected from the group consisting of allulose, fructose, galactose, glucose, high fructose corn syrup lactose, maltose, maltulose, sucrose. In some aspects, the one or more nutritive sweeteners is selected from the group consisting of high fructose corn syrup and sucrose, and combinations thereof and from about 0.05 wt % to about 5 wt % of one or more steviol glycosides. In some aspects the steviol glycoside is selected from the group consisting of rebaudioside A, rebaudioside D, rebaudioside M, and combinations thereof.

In some aspects, the present disclosure provides a powder base comprising from about 1 wt % to about 50 wt % of collagen, from about 10 wt % to about 50 wt % of one or more acids, from about 10 wt % to about 50 wt % of one or more bases, and one or both of:
about 0.1 wt % to about 10 wt % of a polyphenol-containing substance; and
about 0.1 wt % to about 10 wt % of a glycolipid.

In some aspects, the present disclosure provides a powder base comprising from about 10 wt % to about 50 wt % of collagen, from about 20 wt % to about 40 wt % of one or more acids, from about 20 wt % to about 40 wt % of one or more bases, and one or both of:
about 0.1 wt % to about 1 wt % of a polyphenol-containing substance; and
about 0.1 wt % to about 1 wt % of a glycolipid.

In some aspects, the present disclosure provides a powder base comprising from about 20 wt % to about 50 wt % of collagen, from about 25 wt % to about 35 wt % of one or more acids, from about 25 wt % to about 35 wt % of one or more bases, and one or both of:
about 0.1 wt % to about 0.8 wt % of a polyphenol-containing substance; and
about 0.1 wt % to about 0.8 wt % of a glycolipid.

In some aspects, the present disclosure provides a powder base comprising from about 1 wt % to about 50 wt % of collagen, from about 10 wt % to about 50 wt % of one or more acids selected from the group consisting of ascorbic acid, citric acid, lactic acid, malic acid, tartaric acid, and combinations thereof, from about 10 wt % to about 50 wt % of one or more bases selected from the group consisting of potassium bicarbonate, potassium carbonate, sodium bicarbonate, sodium carbonate, potassium hydroxide, sodium hydroxide, and combinations thereof, and one or both of:
about 0.1 wt % to about 10 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof; and
about 0.1 wt % to about 10 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 10 wt % to about 50 wt % of collagen, from about 20 wt % to about 40 wt % of one or more acids selected from the group consisting of ascorbic acid, citric acid, lactic acid, malic acid, tartaric acid, and combinations thereof, from about 20 wt % to about 40 wt % of one or more bases selected from the group consisting of potassium bicarbonate, potassium carbonate, sodium bicarbonate, sodium carbonate, potassium hydroxide, sodium hydroxide, and combinations thereof, and one or both of:
about 0.1 wt % to about 1 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof, and
about 0.1 wt % to about 1 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 20 wt % to about 50 wt % of collagen, from about 25 wt % to about 35 wt % of one or more acids selected from the group consisting of ascorbic acid, citric acid, lactic acid, malic acid, tartaric acid, and combinations thereof, from about 25 wt % to about 35 wt % of one or more bases selected from the group consisting of potassium bicarbonate, potassium carbonate, sodium bicarbonate, sodium carbonate, potassium hydroxide, sodium hydroxide, and combinations thereof, and one or both of:
about 0.1 wt % to about 0.8 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof; and
about 0.1 wt % to about 0.8 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 1 wt % to about 50 wt % of collagen, from about 10 wt % to about 50 wt % of citric acid, from about 10 wt % to about 50 wt % of sodium bicarbonate, and one or both of:
about 0.1 wt % to about 10 wt % of a polyphenol-containing substance selected from the group consisting of whole apple extract, grape seed extract, grapefruit extract, and combinations thereof; and
about 0.1 wt % to about 10 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 10 wt % to about 50 wt % of collagen, from about 20 wt % to about 40 wt % of citric acid, from about 20 wt % to about 40 wt % of sodium bicarbonate, and one or both of:
about 0.1 wt % to about 1 wt % of a polyphenol-containing substance selected from the group consisting of whole apple extract, grape seed extract, and combinations thereof, and
about 0.1 wt % to about 1 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 20 wt % to about 50 wt % of collagen, from about 25 wt % to about 35 wt % of citric acid, from about 25 wt % to about 35 wt % of sodium bicarbonate, and one or both of:
about 0.1 wt % to about 0.8 wt % of a polyphenol-containing substance selected from the group consisting of whole apple extract, grape seed extract, and combinations thereof, and
about 0.1 wt % to about 0.8 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 1 wt % to about 50 wt % of collagen, from about 10 wt % to about 50 wt % of one or more acids, from about 10 wt % to about 50 wt % of one or more bases, from about 0.05 wt % to about 5 wt % of a non-nutritive sweetener, and one or both of:
about 0.1 wt % to about 10 wt % of a polyphenol-containing substance; and
about 0.1 wt % to about 10 wt % of a glycolipid.

In some aspects, the present disclosure provides a powder base comprising from about 10 wt % to about 50 wt % of collagen, from about 20 wt % to about 40 wt % of one or more acids, from about 20 wt % to about 40 wt % of one or more bases, from about 0.05 wt % to about 3.5 wt % of a non-nutritive sweetener, and one or both of:
about 0.1 wt % to about 1 wt % of a polyphenol-containing substance; and
about 0.1 wt % to about 1 wt % of a glycolipid.

In some aspects, the present disclosure provides a powder base comprising from about 20 wt % to about 50 wt % of collagen, from about 25 wt % to about 35 wt % of one or more acids, from about 25 wt % to about 35 wt % of one or more bases, from about 0.05 wt % to about 1.5 wt % of a non-nutritive sweetener, and one or both of:
about 0.1 wt % to about 0.8 wt % of a polyphenol-containing substance; and
about 0.1 wt % to about 0.8 wt % of a glycolipid.

In some aspects, the present disclosure provides a powder base comprising from about 1 wt % to about 50 wt % of collagen, from about 10 wt % to about 50 wt % of one or more acids selected from the group consisting of ascorbic acid, citric acid, lactic acid, malic acid, tartaric acid, and combinations thereof, from about 10 wt % to about 50 wt % of one or more bases selected from the group consisting of potassium bicarbonate, potassium carbonate, sodium bicarbonate, sodium carbonate, potassium hydroxide, sodium hydroxide, and combinations thereof, from about 0.05 wt % to about 5 wt % of a non-nutritive sweetener selected from the group consisting of aspartame, acesulfame potassium, erythritol, neotame, saccharin, sucralose, xylitol, monk fruit, a steviol glycoside, and combinations thereof, and one or both of:
about 0.1 wt % to about 10 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof; and
about 0.1 wt % to about 10 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 10 wt % to about 50 wt % of collagen, from about 20 wt % to about 40 wt % of one or more acids selected from the group consisting of ascorbic acid, citric acid, lactic acid, malic acid, tartaric acid, and combinations thereof, from about 20 wt % to about 40 wt % of one or more bases selected from the group consisting of potassium bicarbonate, potassium carbonate, sodium bicarbonate, sodium carbonate, potassium hydroxide, sodium hydroxide, and combinations thereof, from about 0.05 wt % to about 3.5 wt % ppm of a non-nutritive sweetener selected from the group consisting of aspartame, acesulfame potassium, erythritol, neotame, saccharin, sucralose, xylitol, monk fruit, a steviol glycoside, and combinations thereof, and one or both of:
about 0.1 wt % to about 1 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof; and
about 0.1 wt % to about 1 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 20 wt % to about 50 wt % of collagen, from about 25 wt % to about 35 wt % of one or more acids selected from the group consisting of ascorbic acid, citric acid, lactic acid, malic acid, tartaric acid, and combinations thereof, from about 25 wt % to about 35 wt % of one or more bases selected from the group consisting of potassium bicarbonate, potassium carbonate, sodium bicarbonate, sodium carbonate, potassium hydroxide, sodium hydroxide, and combinations thereof, from about 0.05 wt % to about 1.5 wt % of a non-nutritive sweetener selected from the group consisting of aspartame, acesulfame potassium, erythritol, neotame, saccharin, sucralose, xylitol, monk fruit, a steviol glycoside, and combinations thereof, and one or both of:
about 0.1 wt % to about 0.8 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof; and
about 0.1 wt % to about 0.8 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 1 wt % to about 50 wt % of collagen, from about 10 wt % to about 50 wt % of citric acid, from about 10 wt % to about 50 wt % of sodium bicarbonate, from about 10 ppm to about 1000 ppm of a steviol glycoside, and one or both of:
about 0.1 wt % to about 10 wt % of a polyphenol-containing substance selected from the group consisting of whole apple extract, grape seed extract, and combinations thereof, and
about 0.1 wt % to about 10 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 10 wt % to about 50 wt % of collagen, from about 20 wt % to about 40 wt % of citric acid, from about 20 wt % to about 40 wt % of sodium bicarbonate, from about 75 ppm to about 450 ppm of steviol glycoside, and one or both of:
about 0.1 wt % to about 1 wt % of a polyphenol-containing substance selected from the group consisting of whole apple extract, grape seed extract, and combinations thereof, and
about 0.1 wt % to about 1 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 20 wt % to about 50 wt % of collagen, from about 25 wt % to about 35 wt % of citric acid, from about 25 wt % to about 35 wt % of sodium bicarbonate, from about 100 ppm to about 300 ppm of a steviol glycoside, and one or both of:
about 0.1 wt % to about 0.8 wt % of a polyphenol-containing substance selected from the group consisting of whole apple extract, grape seed extract, and combinations thereof, and
about 0.1 wt % to about 0.8 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 1 wt % to about 50 wt % of collagen, from about 10 wt % to about 50 wt % of one or more acids, from about 10 wt % to about 50 wt % of one or more bases, from about 1 wt % to about 85 wt % of a nutritive sweetener, and one or both of:
about 0.1 wt % to about 10 wt % of a polyphenol-containing substance; and
about 0.1 wt % to about 10 wt % of a glycolipid.

In some aspects, the present disclosure provides a powder base comprising from about 10 wt % to about 50 wt % of collagen, from about 20 wt % to about 40 wt % of one or more acids, from about 20 wt % to about 40 wt % of one or more bases, from about 0.1 wt % to about 75 wt % of a nutritive sweetener, and one or both of:
about 0.1 wt % to about 1 wt % of a polyphenol-containing substance; and
about 0.1 wt % to about 1 wt % of a glycolipid.

In some aspects, the present disclosure provides a powder base comprising from about 20 wt % to about 50 wt % of collagen, from about 25 wt % to about 35 wt % of one or more acids, from about 25 wt % to about 35 wt % of one or more bases, from about 1 wt % to about 65 wt % of a nutritive sweetener, and one or both of:
about 0.1 wt % to about 0.8 wt % of a polyphenol-containing substance; and
about 0.1 wt % to about 0.8 wt % of a glycolipid.

In some aspects, the present disclosure provides a powder base comprising from about 1 wt % to about 50 wt % of collagen, from about 10 wt % to about 50 wt % of one or more acids selected from the group consisting of ascorbic acid, citric acid, lactic acid, malic acid, tartaric acid, and combinations thereof, from about 10 wt % to about 50 wt % of one or more bases selected from the group consisting of potassium bicarbonate, potassium carbonate, sodium bicarbonate, sodium carbonate, potassium hydroxide, sodium hydroxide, and combinations thereof, from about 1 wt % to about 85 wt % of a nutritive sweetener selected from the group consisting of allulose, fructose, galactose, glucose, high fructose corn syrup lactose, maltose, maltulose, sucrose and combinations thereof, and one or both of:
about 0.1 wt % to about 10 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof; and
about 0.1 wt % to about 10 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 10 wt % to about 50 wt % of collagen, from about 20 wt % to about 40 wt % of one or more acids selected from the group consisting of ascorbic acid, citric acid, lactic acid, malic acid, tartaric acid, and combinations thereof, from about 20 wt % to about 40 wt % of one or more bases selected from the group consisting of potassium bicarbonate, potassium carbonate, sodium bicarbonate, sodium carbonate, potassium hydroxide, sodium hydroxide, and combinations thereof, from about 20 wt % to about 75 wt % of a nutritive sweetener selected from the group consisting of allulose, fructose, galactose, glucose, high fructose corn syrup lactose, maltose, maltulose, sucrose and combinations thereof, and one or both of:
about 0.1 wt % to about 1 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof, and
about 0.1 wt % to about 1 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 20 wt % to about 50 wt % of collagen, from about 25 wt % to about 35 wt % of one or more acids selected from the group consisting of ascorbic acid, citric acid, lactic acid, malic acid, tartaric acid, and combinations thereof, from about 25 wt % to about 35 wt % of one or more bases selected from the group consisting of potassium bicarbonate, potassium carbonate, sodium bicarbonate, sodium carbonate, potassium hydroxide, sodium hydroxide, and combinations thereof, from about from about 30 wt % to about 65 wt % of a nutritive sweetener selected from the group consisting of allulose, fructose, galactose, glucose, high fructose corn syrup lactose, maltose, maltulose, sucrose and combinations thereof, and one or both of:
about 0.1 wt % to about 0.8 wt % of a polyphenol-containing substance selected from the group consisting of whole apple extract, apricot extract, artichoke extract, asparagus extract, black bean extract, bitter almond extract, blackberry extract, black currant extract, blueberry extract, broccoli extract, carrot extract, cherry extract, coffee extract, chocolate extract, grape seed extract, grapefruit extract, lemon extract, nectarine extract, peach extract, pear extract, pomegranate extract, plum extract, raspberry extract, red currant extract, strawberry extract, sumac extract, tea extract, turmeric extract, and combinations thereof; and
about 0.1 wt % to about 0.8 wt % of a glycolipid selected from the group consisting of glycoglycerolipids, glycosphingolipids, sugar-linked sugar alcohol lipids, phosphoglycolipds, trehalose glycolipids, sophorose glycolipids, rhamnose glycolipids, phenolic glycoloipds, steryl glycolipids, Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 1 wt % to about 50 wt % of collagen, from about 10 wt % to about 50 wt % of citric acid, from about 10 wt % to about 50 wt % of sodium bicarbonate, from about 1 wt % to about 85 wt % of a nutritive sweetener selected from the group consisting of sucrose, glucose, fructose, and a mixture thereof, and one or both of:
about 0.1 wt % to about 10 wt % of a polyphenol-containing substance selected from the group consisting of whole apple extract, grape seed extract, and combinations thereof, and
about 0.1 wt % to about 10 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 10 wt % to about 50 wt % of collagen, from about 20 wt % to about 40 wt % of citric acid, from about 20 wt % to about 40 wt % of sodium bicarbonate, from about 1 wt % to about 75 wt % of a nutritive sweetener selected from the group consisting of sucrose, glucose, fructose, and a mixture thereof, and one or both of:
about 0.1 wt % to about 1 wt % of a polyphenol-containing substance selected from the group consisting of whole apple extract, grape seed extract, and combinations thereof, and
about 0.1 wt % to about 1 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

In some aspects, the present disclosure provides a powder base comprising from about 20 wt % to about 50 wt % of collagen, from about 25 wt % to about 35 wt % of citric acid, from about 25 wt % to about 35 wt % of sodium bicarbonate, from about 1 wt % to about 65 wt % of a nutritive sweetener selected from the group consisting of sucrose, glucose, fructose, and a mixture thereof, and one or both of:
about 0.1 wt % to about 0.8 wt % of a polyphenol-containing substance selected from the group consisting of whole apple extract, grape seed extract, and combinations thereof, and
about 0.1 wt % to about 0.8 wt % of Glycolipid Mixture 1 (wherein the weight ratio of Compound A to Compound B in Glycolipid Mixture 1 is from about 1:99 to about 99:1 and the weight ratio of Compound B to Compound C in the mixture is from about 1:99 and about 99:1; or the weight ratio of Compound A to Compound B in the mixture is from about 10:90 to about 90:10 and the weight ratio of Compound B to Compound C in the mixture is from about 10:90 and about 90:10; or the weight ratio of Compound A to Compound B in the mixture is from about 20:80 to about 80:20 and the weight ratio of Compound B to Compound C in the mixture is from about 20:80 and about 80:20; or the weight ratio of Compound A to Compound B in the mixture is from about 30:70 to about 70:30 and the weight ratio of Compound B to Compound C in the mixture is from about 30:70 and about 70:30; or the weight ratio of Compound A to Compound B in the mixture is from about 40:60 to about 60:40 and the weight ratio of Compound B to Compound C in the mixture is from about 40:60 and about 60:40; or the weight ratio of Compound A to Compound B in the mixture is about 50:50 and the weight ratio of Compound B to Compound C in the mixture is about 50:50), and combinations thereof.

To measure the foam generated by the addition of the powder base to water, a 500 mL PMP plastic graduated cylinder containing a stir bar was filled with 220 mL pure ambient temperate reverse osmosis water—or ambient temperature water with sugar pre-dissolved if appropriate for the sample being analyzed. The graduated cylinder was placed on a stir plate that was set to 1200 rpm. A tube containing the powder base sample (4.3 g) was inverted and dispensed into the cylinder. The resulting mixture was stirred for 5 seconds, then stirring was immediately halted. The level of foam in the graduated cylinder was recorded 30 seconds after the powder was dispended into water and was also recorded at 1, 2, 3, and 4 minutes post-addition. In some aspects, the powder base has a property that an initial foam volume of from about 100 mL to about 150 mL is provided when the powder is added to water.

In any of the foregoing aspects, the powder base has a property that when the powder is added to water as described above, the resulting mixture holds a foam volume of about 25 mL or more for 2 minutes or longer. In some aspects, the resulting mixture holds a foam volume of about 25 mL or more for 3 minutes or longer. In some aspects, the resulting mixture holds a foam volume of about 25 mL or more for 4 minutes or longer.

In some aspects, the powder base has a property that when the powder is added to water as described above, the resulting mixture has an initial foam volume of about 100 mL In some aspects, the powder base has a property that when the powder is added to water, the resulting mixture has an initial foam volume of about 125 mL In some aspects, the powder base has a property that when the powder is added to water, the resulting mixture has an initial foam volume of about 150 mL.

### Methods of the Disclosure

The present disclosure is based, at least in part, on the discovery that it is possible to provide an effervescent healthy beverage having a foam head. In some aspects, the desirable foaming properties are produced by a combination of one more glycolipids and/or one or more polyphenol-containing substances. Accordingly, in some aspects, the present disclosure provides a method of enhancing foam stability in a beverage, the method comprising adding the powder base from one or more glycolipids and/or polyphenols to provide a ready-to-drink powder base.

In some aspects, the present disclosure provides a method of enhancing foam stability in a beverage, the method comprising adding a powder base to water or other food-safe diluent, the powder base comprising a glycolipid and/or a polyphenol of the varying types and in the amounts described above, an acid typically present as a solid of the varying types and in the amounts described above, a base of the varying types and in the amounts described above, and collagen of the varying types and in the amounts described above. In some aspects, the powder base further comprises a nutritive sweetener of the varying types and in the amounts described above and/or a non-nutritive sweetener of the varying types and in the amounts described above.

### Beverages

The present disclosure further relates to beverages that can comprise, consist essentially of, or consist of a powder base according to any of the aspects described herein dispensed in a liquid.

In certain embodiments, the beverage is selected from the group consisting of enhanced sparkling beverage, cola, lemon-lime flavored sparkling beverage, orange flavored sparkling beverage, grape flavored sparkling beverage, strawberry flavored sparkling beverage, grape flavored sparkling beverage, pineapple flavored sparkling beverage, ginger-ale, soft drink, root beer, fruit juice, fruit-flavored juice, juice drink, nectar, vegetable juice, vegetable-flavored juice, sports drink, energy drink, enhanced water drink, coconut water, tea-type drink, coffee, cocoa drink, beverage containing milk components, beverage containing cereal extract, frozen beverage, and a smoothie.

In some aspects, the beverage can be a ready to drink beverage. In some aspects, the ready to drink beverage can be disposed in a sealed container. The container can be any suitable receptacle that can be sealed after filling, such as a can (e.g., a metal can, such as an aluminum can), carton, bottle (e.g., a glass bottle, a polyester or polyethylene terephthalate (PET) bottle), or keg. In some aspects, the ready to drink beverage can be disposed in a sealed can (e.g., an aluminum can). In some aspects, the ready to drink beverage can be disposed in a sealed carton. In some aspects, the ready to drink beverage can be disposed in a sealed bottle (e.g., a glass bottle). In some aspects, the ready to drink beverage can be disposed in a sealed keg.

In some aspects, the beverage can be prepared by adding about 4 g to about 5 g of the powder base to about 200 mL to about 300 mL of a liquid.

### EXAMPLES

### General Procedure for Obtaining Foam Data

A 500 mL PMP plastic graduated cylinder containing a stir bar was filled with 220 mL pure ambient temperate reverse osmosis water—or ambient temperature water with sugar pre-dissolved if appropriate for the sample being analzyed. The graduated cylinder was placed on a stir plate that was set to 1200 rpm. A tube containing the powder base sample (4.3 g) was inverted and dispensed into the cylinder. The resulting mixture was stirred for 5 seconds, then stirring was immediately halted. The level of foam in the graduated cylinder was recorded 30 seconds after the powder was dispended into water and was also recorded at 1, 2, 3, and 4 minutes post-addition.

### Preparation of Control Solutions

Since sugar helps to stabilize collagen foam, a control powder base consisting of collagen, acid, and carbonate was assessed for foam generation and stability using the previously explained method at different ° Brix of pre-dissolved sugar and water. The powder base was dispersed into 7.5 fl oz—or 222 mL—of the 0, 3, 7, and 11° Brix solution in replicates of three. Formulation of the control powder base is detailed in Table 1, and the formulations of the ° Brix solutions created to disperse the control powder base into is detailed in Table 2.

TABLE 1
Components of Control Powder Base

| | Foaming Powder |
|---|---|
| Ingredient | Base |
| Na Bicarbonate | 1.27 |
| (g) | |
| Citric Acid (g) | 1.51 |
| Collagen (g) | 1.5 |

TABLE 2
Solutions for Dispersion of Control Powder Base

| °Brix | 0 | 3 | 7 | 11 |
|---|---|---|---|---|
| RO Water (g) | 1000 | 970 | 930 | 890 |
| Sucrose (g) | 0 | 30 | 70 | 110 |

Bovine collagen, whole apple extract, grape seed extract, sodium bicarbonate, sucrose, and citric acid can be purchased commercially. Glycolipids can be purchased commercially from vendors such as Sigma-Aldrich.

A mixture of the collagen, acid, and base was used in each of the test samples. The polyphenol additive being tested was added to the mixture to form the powder base. The powder bases were subjected to the General Procedure for Obtaining Foam Data described above. The powder bases that were tested are shown below in Table 3.

TABLE 3
Components of Sample Powder Bases

| Ex. | | Sodium | Citric | |
|---|---|---|---|---|
| No. | Collagen | Bicarbonate | Acid | Additive |
| 1 | 1.5 g | 1.27 g | 1.51 g | 0.0167 g whole apple |
| | | | | extract |
| 2 | 1.5 g | 1.27 g | 1.51 g | 0.0167 grape seed |
| | | | | extract |
| 3 | 1.5 g | 1.27 g | 1.51 g | 0.0167 g Glycolipid |
| | | | | Mixture 1 |
| 4 | 1.5 g | 1.27 g | 1.51 g | 0.0167 g whole apple |
| | | | | extract, 0.0167 g |
| | | | | grape seed extract, |
| | | | | and 0.0167 g |
| | | | | Glycolipid Mixture 1 |
| 5 | 1.5 g | 1.27 g | 1.51 g | 0.0167 g whole apple |
| | | | | extract, and 0.0167 g |
| | | | | Glycolipid Mixture 1 |
| 6 | 1.5 g | 1.27 g | 1.51 g | 0.0167 g grape seed |
| | | | | extract, and 0.0167 g |
| | | | | Glycolipid Mixture 1 |
| 7 | 1.5 g | 1.27 g | 1.51 g | 0.0167 g whole apple |
| | | | | extract and 0.0167 g |
| | | | | grape seed extract |
| 8 | 1.5 g | 1.27 g | 1.51 g | 0.0084 g whole apple |
| | | | | extract and 0.0084 |
| | | | | grape seed extract |

### Testing Results

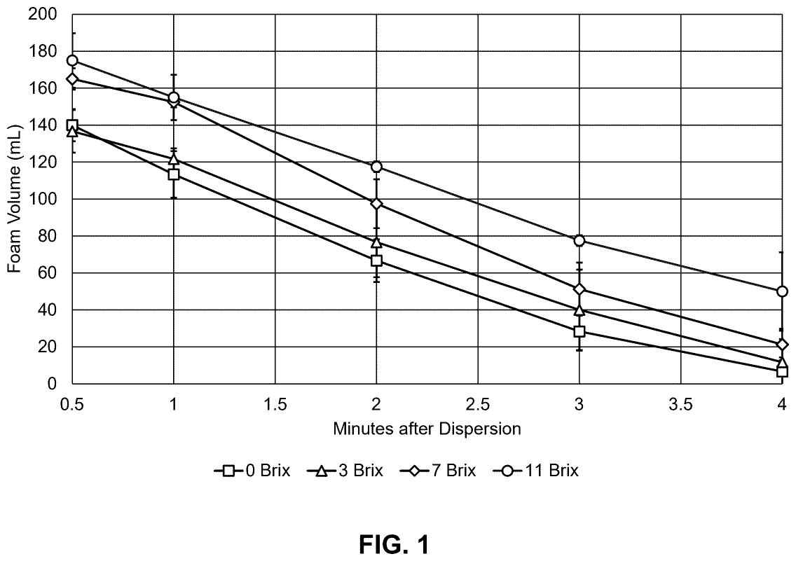

The average foam generation and stability of the control powder base at different ° Brix is shown in Table 4 and FIG. 1. At 0° Brix, the average initial foam height was 140 mL; after 4 minutes, the volume was reduced to 7 mL. As the ° Brix increased from 3 to 11, so did the initial foam height and its overall stability. At 11° Brix, the average foam height was 175 mL; after 4 minutes, the volume was reduced to 50 mL.

TABLE 1
Foam Volue Over Time for Control Powder Base in Varying Degrees Brix

| | Foam Volume (mL) | | | | |
|---|---|---|---|---|---|
| °Brix | 0.5 min | 1 min | 2 min | 3 min | 4 min |
| 0 | 140 ± 8.7 | 113.3 ± 12.6 | 66.7 ± 11.5 | 28.3 ± 10.4 | 6.7 ± 7.6 |
| 3 | 136.7 ± 11.7 | 121.7 ± 11.5 | 76.7 ± 5.8 | 40 ± 18.9 | 11.7 ± 12.6 |
| 7 | 165 ± 5.8 | 152.5 ± 2.9 | 97.5 ± 13.2 | 51.3 ± 14.4 | 21.3 ± 8.5 |
| 11 | 175 ± 14.7 | 155 ± 12.2 | 117.5 ± 2.9 | 77.5 ± 2.9 | 50 ± 21.2 |

As shown in Table 4 and FIG. 1, the 11° Brix mixture showed good foam generation and better foam stability than the other mixtures. But as many consumers prefer low sugar or sugar-free beverages, the other powder bases were tested as alternatives.

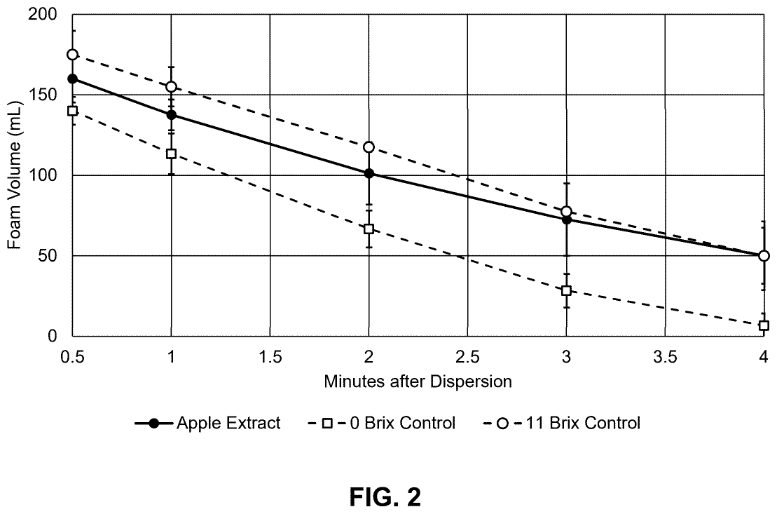

FIG. 2 shows the initial foam generation and foam stability of the powder powder base containing whole apple extract (Example 1 from Table 3) along with the 0° Brix and 11° Brix controls. The average initial foam volume of Example 1 increased to 160 mL (larger than the initial foam volume of 0° Brix) but lower than the initial foam volume of the 11° Brix control, 175 mL. The stability of the foam with whole apple extract matched the average foam volume at 4 minutes of the 11° Brix control.

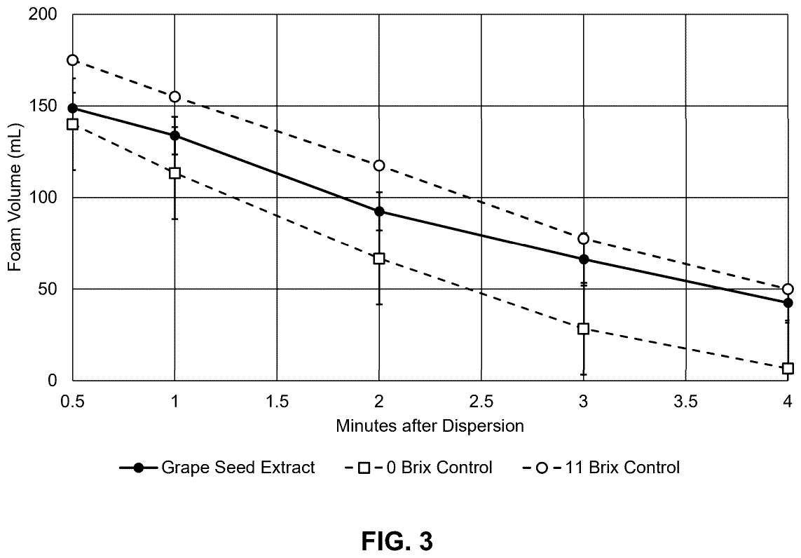

FIG. 3 shows the initial foam generation and foam stability of the powder powder base containing grape seed extract (Example 2 from Table 3). As shown in the figure, the grape seed extract did not provide an initial foam increase as great as the 11° Brix control. It did, however, increase the foam stability in comparison to the 0° Brix control. After 4 minutes, the average foam volume with grape seed extract was 42.5 mL, compared to the 6.7 mL of the 0° Brix control.

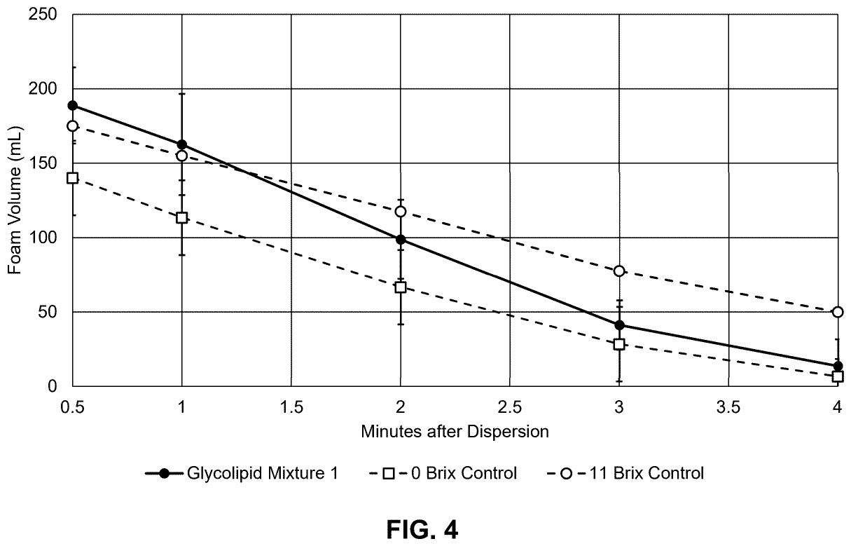

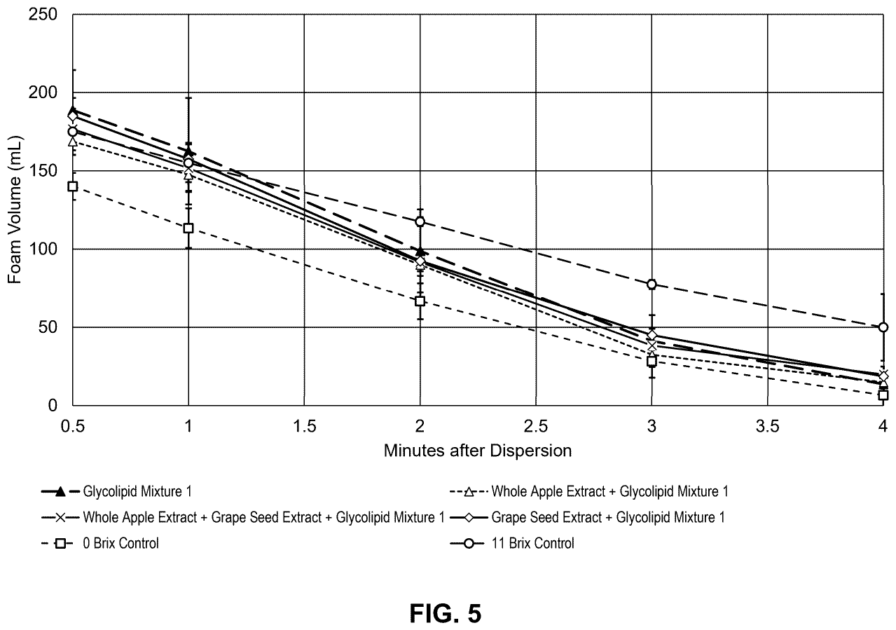

FIG. 4 shows the initial foam generation and foam stability of the powder base beverage containing Glycolipid mixture 1 (Example 3 from Table 3), along with the 11° Brix and 0° Brix controls. The inclusion of Glycolipid mixture 1 surprisingly increased the average initial foam volume, surpassing the 11° Brix control's average initial foam volume at 189 mL. This initial foam generation did not result in an increased foam stability, however. The collapse of the foam in the first 3 minutes of monitoring occurred at a greater rate than that of the 11° Brix control, represented by the higher negative slope of in FIG. 5. From 3 to 4 minutes, the rate of foam collapse of Example 3 aligns more closely with that of both controls. So, while Glycolipid mixture 1 created more foam than the 11° Brix control without using sugar, the foam had a lower stability.

FIG. 5 shows the initial foam generation and foam stability of the powder base beverage containing combinations of Glycolipid mixture 1 with whole apple extract, grape seed extract, or a mixture of both (Examples 5, 6, and 4, respectively, from Table 3). When either grape seed extract or whole apple extract was combined with Glycolipid mixture 1, the initial foam generation was improved in a similar way as when Glycolipd mixture 1 was added alone, but to a lower degree. Combinations of Glycolipid mixture 1 were close to or surpassed the 11° Brix control initial foam volume. The foam collapse pattern in each combination was similar to when Glycolipid mixture 1 was used on its own.

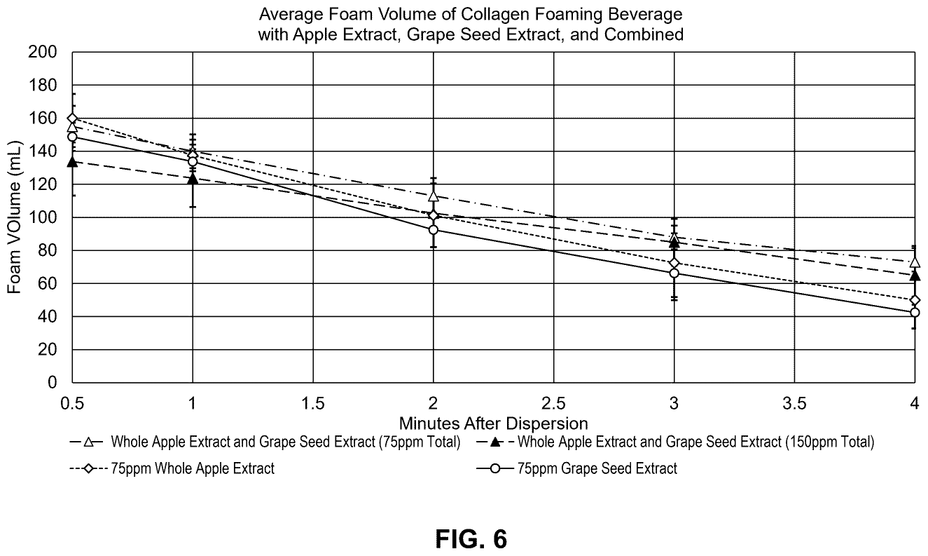

As whole apple extract and grape seed extract both showed positive results, the two were combined to investigate potential synergy. FIG. 6 shows the initial foam generation and foam stability of the powder base beverage containing combinations of whole apple extract and grape seed extract at different concentrations (Examples 7 and 8 from Table 3). While the initial foam generation was comparable to that of the single agents, the overall stability of the combinations was greatly improved.

As shown in the figures and described above, adding a glycolipid and/or polyphenol to collagen containing ready-to-mix powder powder bases improves the beverage's foam properties. The use of these additives provides beverages that have a good initial foam height and/or provide a more stable foam over time and lower amounts of sugar.

Beverages containing polyphenols may also provide additional health benefits such as lowering the incidence of chronic diseases, increasing collagen production, strengthening of collagen-based tissues, and improvement in skin appearance.

It is to be appreciated that the Detailed Description section, and not the Summary and Abstract sections, is intended to be used to interpret the claims. The Summary and Abstract sections may set forth one or more but not all exemplary aspects of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. A powder base for preparing a beverage comprising:
a) collagen;
b) one or more acids;
c) one or more bases; and
d) one or both of:
i) a polyphenol-containing substance, and
ii) a glycolipid.

2. The powder base of claim 1, wherein the glycolipid is selected from the group consisting of glycoglycerolipids, glycosphingolipids, sugar-linked sugar alcohol lipids. phosphoglycolipds, trehalose glycolipids, sophorose glycolipids, rhamnose glycolipids, phenolic glycoloipds, steryl glycolipids, and combinations thereof.

3.-4. (canceled)

5. The powder base of claim 2, wherein the sugar-linked sugar alcohol lipids are selected from the group consisting of mannosylerythritol lipids, acremomannolipin A, and a combination thereof.

6. The powder base of claim 1, wherein the glycolipid is a compound of Formula I, Formula II, or a combination thereof: 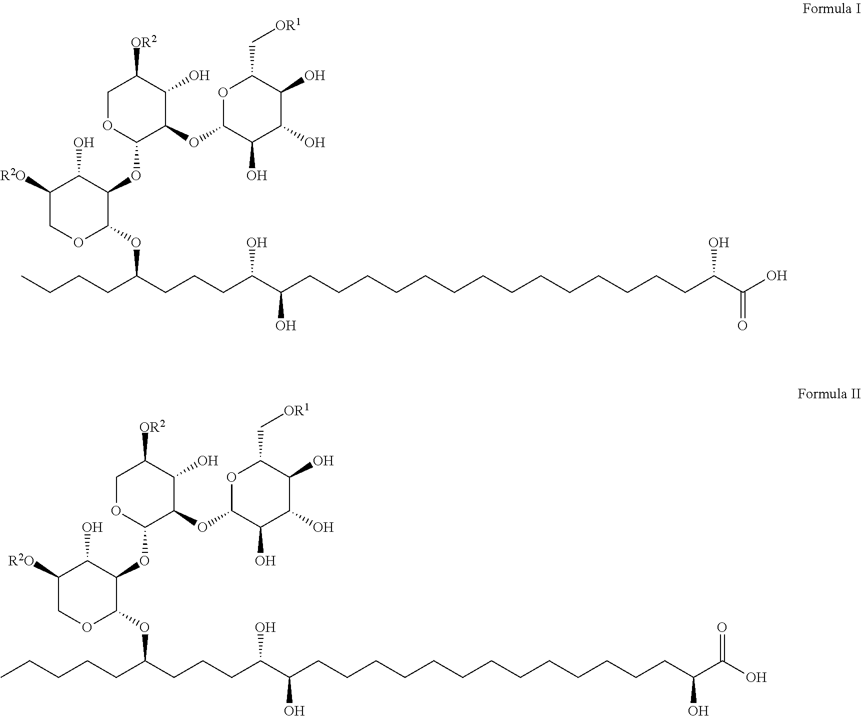
wherein R¹ is C(O)CH₃ or C(O)CH₂CH(CH₃)₂ and wherein R² is hydrogen or C(O)CH₃.

7. The powder base of claim 1, wherein the powder base comprises from about 0.1 wt % to about 1 wt % of the glycolipid.

8. (canceled)

9. The powder base of claim 1, wherein the powder base comprises from about 0.1 wt % to about 1 wt % of the polyphenol-containing substance.

10.-13. (canceled)

14. The powder base of claim 1, wherein the powder base comprises from about 1 wt % to about 50 wt % collagen.

15. A beverage comprising water and:
a) collagen; and
b) one or both of:
i) a polyphenol-containing substance, and
ii) a glycolipid.

16. The beverage of claim 15, wherein the glycolipid is selected from the group consisting of glycoglycerolipids, glycosphingolipids, sugar-linked sugar alcohol lipids. phosphoglycolipds, trehalose glycolipids, sophorose glycolipids, rhamnose glycolipids, phenolic glycoloipds, steryl glycolipids, and combinations thereof.

17.-19. (canceled)

20. The beverage of claim 15, wherein the glycolipid is a compound of Formula I, Formula II, or a combination thereof: 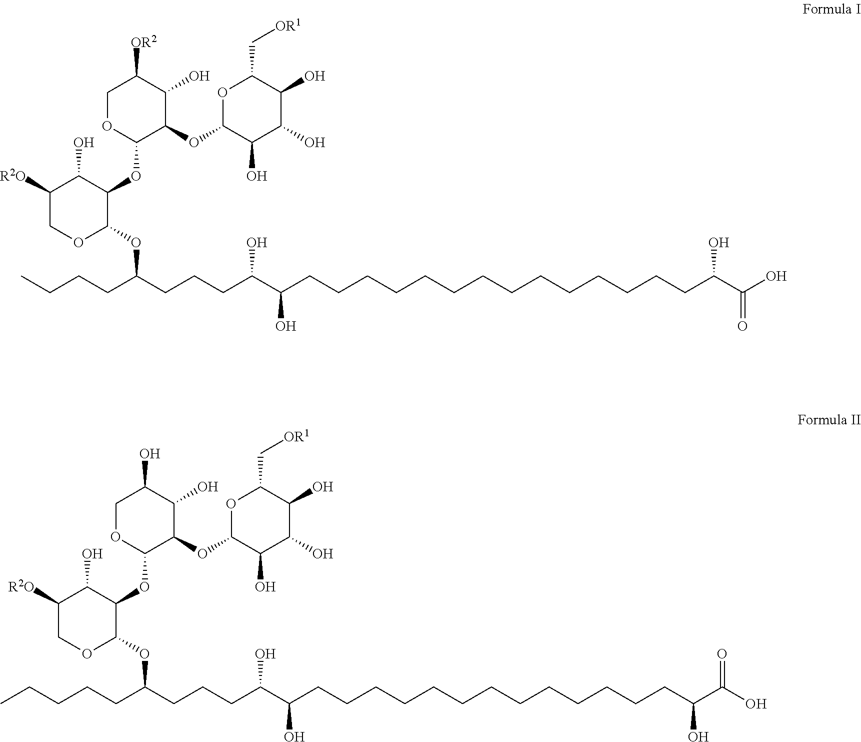
wherein R¹ is C(O)CH₃ or C(O)CH₂CH(CH₃)₂ and wherein R² is hydrogen or C(O)CH₃.

21. The beverage of claim 15, wherein the beverage comprises from about 75 ppm to about 150 ppm of the glycloipid.

22. (canceled)

23. The beverage of claim 15, wherein the beverage comprises from about 75 ppm to about 150 ppm of the one or more polyphenol-containing substances.

24. The beverage of claim 15, wherein the beverage comprises about 0.5 wt % to about 5 wt % of collagen.

25. The beverage of claim 15, wherein the beverage further comprises one or more sweeteners.

26.-31. (canceled)

32. A method of preparing the beverage of claim 15, the method comprising adding a powder base comprising:
a) collagen;
b) one or more acids;
c) one or more bases; and
d) one or both of:
i) a polyphenol-containing substance, and
ii) a glycolipid;
to water.

33. The method of claim 32, wherein the glycolipid is selected from the group consisting of glycoglycerolipids, glycosphingolipids, sugar-linked sugar alcohol lipids. phosphoglycolipds, trehalose glycolipids, sophorose glycolipids, rhamnose glycolipids, phenolic glycoloipds, steryl glycolipids, and combinations thereof.

34.-36. (canceled)

37. The method of claim 32, wherein the glycolipid is a compound of Formula I, Formula II, or a combination thereof: 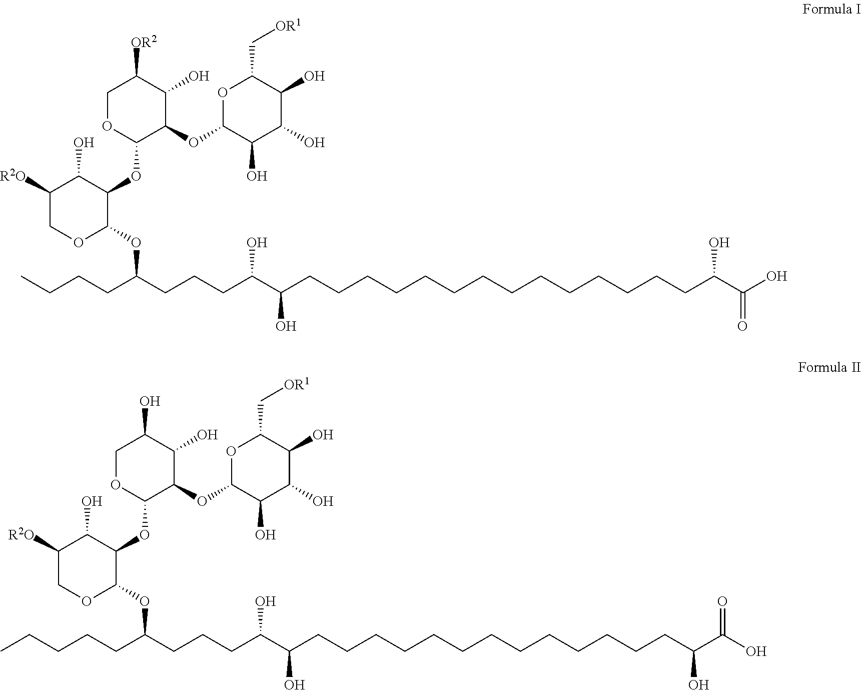
wherein R¹ is C(O)CH₃ or C(O)CH₂CH(CH₃)₂ and wherein R² is hydrogen or C(O)CH₃.

38. The method of claim 32, wherein the powder base comprises from about 0.1 wt % to about 1 wt % of the glycolipid.

39. (canceled)

40. The method of claim 32, wherein the powder base comprises from about 0.1 wt % to about 1 wt % of the polyphenol-containing substance.

41.-44. (canceled)

45. The method of claim 32, wherein the powder base comprises from about 1 wt % to about 40 wt % collagen.
